(19) United States
(12) Patent Application Publication
(10) Pub. No.: US 2016/0331489 A1
(43) Pub. Date: Nov. 17, 2016

(54) A PRECISION SURGICAL GUIDANCE TOOL SYSTEM AND METHOD FOR IMPLEMENTING DENTAL IMPLANTS

(71) Applicant: GST LTD., West Orange, NJ (US)

(72) Inventors: Daniel SANDERS, Raanana (IL); Ben Zion SPECTOR, Tel Mond (IL)

(73) Assignee: GST LTD., West Orange, NJ (US)

(21) Appl. No.: 15/107,454

(22) PCT Filed: Dec. 23, 2014
(86) PCT No.: PCT/IB2014/067281

§ 371 Date: Jun. 22, 2016

(30) Foreign Application Priority Data
Dec. 23, 2013 (GB) 1322962.0

(51) Int. Cl. A61C 1/08; A61C 8/00

(52) U.S. Cl. CPC A61C 1/084; A61C 8/0089

(57) ABSTRACT

A system, apparatus, device, tools, kit and method is provided for the preparation of the jawbone and insertion of dental implants. The apparatus (1) includes a universal and reusable compact clamping device and removable components for the damp which allow for precision surgical preparation and implantation of dental implants into the jawbone. According to some embodiments, an apparatus is provided that includes a swivel platform (3) having a guide member for receiving a tool for preparing an osteotomy and/or for implanting a dental implant into a jaw bone; an orientation member for positioning of the platform and one or more frames (2,12) connectable to the platform.

### FIELD OF THE INVENTION

The present invention relates generally to dental implants and more particularly to an improved means and method for the preparation and insertion of dental implants.

### BACKGROUND OF THE INVENTION

A dental implant is an artificial prosthesis normally comprised of a single cylindrical component to replace the missing root structure of a natural tooth that has been lost. This standard implant is typically inserted into the jawbone by threading or screwing it into a prepared hollowed out bony site in the jawbone called in the field an osteotomy. The prepared osteotomy typically has a diameter that corresponds to the body dimensions of the implant without its threads and the threads of the implant engage (self-tap) the vertical inner walls of the osteotomy as it is screwed into place. The implant typically remains buried in the bone (endosseous) for a period of time to allow for “osseo-integration” or the growth and adhesion of natural bone around all the external surfaces of the implant, securing and stabilizing it in place so that it can withstand load forces. This cylindrical implant typically contains down its internal center a machined threaded internal hollow sleeve or bore that allows the dental practitioner upon later surgical exposure of the head or top (coronal) section of the cylindrical implant to screw into place a machined screw-in abutment (either with an integral screw on its inferior aspect or a separate connector screw which threads through a center hollow sleeve or bore of the abutment). The abutment, which extends into the oral cavity, is then utilized by the dentist to fabricate a single fixed prosthesis (crown), a multiple fixed prosthesis (dental bridges-multiple crowns connected to each other) in the case of adjacent multiple implants, or can take the form of a fixed prosthesis (over-denture bar prosthesis) to anchor a removable prosthesis such as a permanent denture, using techniques that are widely known in the dental field.

The upper and lower jaws are made up of a narrow strip of softer, spongy, alveolar bone sandwiched between two thin outer hard cortical plates of bone. In the posterior regions the entire width (cheek to tongue or buccal-lingual) of the jawbones is typically only 5 to 7 millimeters thick. The average interdental (anterior-posterior length between the teeth) space remaining when a molar tooth is lost (missing tooth space) is typically 10 to 12 millimeters long. The vertical depth of alveolar bone present where the tooth was lost can be as little as 5 to 10 millimeters before one encounters either the maxillary sinus space (in the upper jaw) and the inferior alveolar nerve (in the lower jaw).

To allow for a proper volume or thickness of jaw bone between the implant and the adjacent teeth so as to allow for a proper blood supply and health of the bone between the implant and the adjacent teeth, it has been accepted in the dental field to maintain a minimum distance of 1.5 to 2 millimeters between the implant and the adjacent teeth on either side of the implant and 1.5 to 3 millimeters between adjacent multiple implants.

This means that the target bone site for the proper placement of a dental implant is very limited and requires the practitioner who wishes to place dental implants safely to exercise considerable care performing the implant procedure after first having acquired a high degree of skill level and clinical experience. This becomes even more difficult for the practitioner when attempting to place multiple dental implants in the same jawbone.

Dental implants are typically placed using the following two surgical techniques: 1. Delayed technique: the unsalvageable tooth is extracted and the entire root socket(s) are allowed to heal with bone filling the void(s) over several months. Once this healing process has been completed, the practitioner opens the gum and drills into the bone to create the osteotomy (bone preparation) to allow for the insertion of the dental implant. 2. Immediate Extraction-Immediate Implant technique: At the same visit, the practitioner extracts the unsalvageable tooth and immediately inserts the dental implant into the fresh root socket voids or using a drill modifies this root socket or drills a new hole and places the implant into it. In the case of a molar tooth extraction the practitioner is left with multiple proximal root socket voids in the jawbone (where the multiple natural roots used to be) and an oval or rhomboid distal void (where the root trunk used to be).

Both surgical techniques require the sequential use of a series of increasing diameter and or length bone drills to properly prepare the osteotomy and so allow for the insertion of the dental implant. This is required in order to safely remove bone tissue in a gradient manner so as not to overheat the surrounding bone as would invariably occur if the largest diameter and length bone drill was used initially instead of the above described drilling protocol.

It is well established medical fact that overheating bone tissue is highly destructive to surrounding bone tissue and leads invariably to necrosis of bone tissue, a highly undesirable outcome.

The vast majority of dental implants are surgically inserted by the dental practitioner into the jawbones of the patient using the above two described surgical techniques in a free-hand manner (i.e. without the aid of any guidance system). As described above, this means that the dental practitioner in order to safely place dental implants relies solely on his/her skill level acquired through his experience, his latent natural talent, and his diligent exercise of care throughout the procedure. This required exercise of care and surgical skill level defined above applies both to both phases of the implantation procedure; namely: the bone preparation (osteotomy) and the subsequent insertion (implantation) of the dental implant into said bone preparation.

It will be appreciated that if the practitioner errs to even a relatively slight degree of 1-2 mm in any straight or angled direction (depth or position) while preparing the osteotomy and while inserting the implant into said bone preparation, s/he risks damaging sensitive anatomical structures as well as ending up with an implant placed in a non-optimal position in relation to the adjacent and opposing teeth and the final dental prosthesis placed onto the implant which will be used for functional biting and chewing and which relies on the implant for structural load support. The dental prosthesis will be secured to the implant once the implant has osseo-integrated (bone having grown in intimate contact around the exterior surface of the implant so that it is now stable). As mentioned above, it will be further appreciated that the required accuracy and precision described above is compounded when multiple implants are placed in the same patient.

In order to reduce the above skill requirements of the dental practitioner, surgical guided stents have in recent years begun to be used in the field in a limited fashion. Such stents are custom-made for each patient (discarded after a single use) and are fabricated using elaborate imaging equipment that has been wedded to sophisticated three dimensional software computer programs and which requires additional specialized dental laboratory fabrication to produce said stent.

This process is both time-consuming and expensive for the dental practitioner in terms of delay of delivery of treatment to the patient, fees to the laboratory, and the costs of the imaging and software licenses. As the stent is custom made for each patient these costs must be repeated for each patient.

The stent is usually made of acrylic materials and is custom shaped to closely conform to the alveolar ridges of the particular patient for whom they are to be placed in, in order to assure an intimate and accurate fit of the stent to the patient's mouth. Single or multiple hollow metal drill guide tubes are incorporated into the body of the stent at the location(s) of the intended implant target bone site(s).

It will be appreciated that these drill guide tubes only provide a location and angle for the practitioner. In order to limit or control the vertical drilling depth, they must be used in conjunction with multiple hand-held instruments that have hollow rings of varying diameters at their working ends and whose rings have circumferential limiting flanges that act as a stop limit in regards to the vertical depth of the bone drill when said bone drill is inserted into it.

The varying diameters of the hollow rings of the hand-held instruments, described above, correspond to varying diameters (of the previously described) sequentially used bone drills that are used to prepare the osteotomy at the target bone site.

In order to secure a surgical stent to the patient's jawbone, multiple pre-drilled holes are incorporated into the stent on the buccal (cheek-side) side wall of the alveolar ridge in a plane that is perpendicular to the crest of the alveolar ridge. Multiple holes are then drilled into the side wall of the buccal surfaces of the jawbone of the patient by the practitioner through said pre-drilled stent holes and metal securing pins are screwed or tapped into these holes to secure the stent to the jawbone. It can be appreciated that this required method for surgically securing the stent is quite invasive to the patient and results in significant post-operative pain and healing.

The above stents are normally placed onto the jawbone after surgical incisions are made to the gum tissue and reflection of the gum tissue has been performed, though some now advocate their use without prior reflecting of the gum tissue.

There is varying thickness of the gum tissue overlying the alveolar ridges in different patients so that reflecting the gum tissue prior to placing the stent onto the alveolar ridge is desirable as this allows for more accurate positioning of the stent directly onto the coronal bone surface of the alveolar ridge.

The circumferential outer lip of the embedded ring tubes of the stents can also be used as a limiting flange to control the vertical depth to which the implant is screwed/threaded into the osteotomy.

It will be obvious that a guidance system that does not require a custom-made surgical stent for each patient yet allows for similar or improved guided drilling and insertion of dental implants would be most advantageous.

### SUMMARY OF THE INVENTION

In accordance with some embodiments, a one time or reusable universal implanting apparatus is provided which comprises a compact surgical clamp apparatus that contains an outer frame, inner frame, swivel platform and guide ring, with individually adjustable positioning elements to clamp and secure itself directly onto the bone or onto the gums and bone of a unilateral section of the jawbone, at an optimal position and angle. According to some embodiments, an apparatus is provided that comprises: a platform suitable for being positioned over a bone and maintained in position for a procedure including preparing a bone for an implant and/or implanting an implant into a bone, said platform having a guide bore therethrough; one or more frames connected to the platform, wherein the one or more frames includes clamp arms that extend to opposing sides of the bone; one or more fixation cleats on each arm, wherein each fixation cleat has a tip suitable for penetrating into a bone and/or gum tissue on the opposing sides of the bone so that the frame is secured to the bone during the procedure; one or more means for adjusting the relative position of the each fixation cleats in relation to the clamp arm retaining it for securing the clamp arms to the bone prior to and during the procedure and for removing the clamp arms from the bone after the procedure; wherein the apparatus includes one or more features for positioning the platform, for changing a position of the platform, for changing an angle of a component attached to the platform or any combination thereof and locking this position of the platform, following the securing of the clamp arms to the bone and prior to the procedure.

According to some embodiments of the present invention, an apparatus is provided, that includes:
i. an outer frame including two or more clamp arms for clamping to opposing sides of a bone;
ii. an inner frame separately attachable to the clamped outer frame to enable sequential attachment of the outer and inner frame with respect to the bone; and
iii. a platform suitable for being positioned over a bone and maintained in position for a procedure including preparing a bone for an implant and/or implanting an implant into a bone, the platform having threaded bores on side surfaces thereof that connect to the inner frame using locking screw elements, said platform having a guide bore therethrough.

In some embodiments, the apparatus further comprising a plurality of individually engageable fixation cleats connectable to each arm, wherein at least one of the fixation cleats has a swivel tip suitable for self-aligning and penetrating into a bone and/or gum tissue on the opposing sides of the bone so that the outer frame is secured to the bone during the procedure.

In some embodiments, the inner frame has at least two articulating arms being connectable to the platform.

In some embodiments, the two or more clamp arms are connected by one or more guide pins and a right or left threaded bolt to enable the two clamp arms to be adjusted simultaneously.

In some embodiments, the platform comprises a single platform connectable to the inner frame at opposing end walls of the platform, said opposing end walls of the platform being curved to allow swiveling of the platform within the inner frame thereby enabling changing of the direction of an angle of the platform relative to the bone, so that the apparatus can be used for preparing dental osteotomies having bores with different angles and different directions of the respective angles.

In some embodiments, the guide bore is provided through a top surface of the platform and receives a guide member for receiving a surgical component, the position of the guide member within the guide bore of the platform being adjustable to change the effective height of the guide member relative to the bone.

In some embodiments, the platform guide bore is adapted to receive an orientation member to aid in the orientation of the platform.

In some embodiments, the platform further includes a locking mechanism for locking the guide member at a selected position relative to the platform.

In some embodiments, the guide member is in the form of a hollow cylinder, the outer wall of the cylinder having a series of fixed projections or teeth for mating with a corresponding projection or tooth that is moveable into and out of the bore thereby enabling engagement with and disengagement from a projection or tooth of the guide member with respect to the platform.

In some embodiments, the clamp arms of the outer frame have an upper region that extend above the crestal height and the occlusal plane of the teeth, wherein the upper region of the clamp arms have a plurality of bore holes and are connected by one or more clamp arm connection screws extending through a bore hole of each clamp arm and by one or more clamp arm guide pins extending through a bore hole of each arm, wherein the bore holes are aligned so that the clamp arms are maintained in a generally parallel relationship.

In some embodiments, each clamp arm of the outer frame has internally threaded bore holes for each of the cleats so that the each of the cleats can be screwed individually against the gum, and the clamp arm connection screw has a knob for screwing the arms together so that the cleats can evenly penetrate the gum tissue and/or the bone independent of the curvature of the gum tissue and/or bone.

In some embodiments, one or more of the cleat tips is a self-adjusting rotatable tip with a separate self-adjusting rotatable limiting face.

In some embodiments, the inner frame includes a guide assembly main frame attachment section inner surface for engaging over the guide pins and the right or left threaded bolt of the outer frame, and an element bore for insertion of a guide assembly attachment screw to secure the inner frame to the clamped outer frame.

In some embodiments, the inner frame slideably engages the guide pins and the right or left threaded bolt of the outer frame.

In some embodiments, each of the articulating arms has a curved inner surface for receiving the platform with a curved inner surface, thereby enabling the connected platform to swivel in all directions.

In some embodiments, the apparatus includes one or more features for positioning the platform, swiveling the platform, changing a position of the platform, changing an angle component of the platform relative to the bone, locking the platform at a selected position relative to the support arms or any combination thereof, following the securement of the clamp arms of the outer frame to the bone and prior to the procedure.

In some embodiments, the apparatus may be used for preparing a dental osteotomy and/or implanting a dental implant into a jaw bone.

According to further embodiments of the present invention, a kit is provided that includes any combination of a clamping apparatus and at least one of, an implant driver tool, a drill guide gauge, an extraction socket gauge, an orientation member or a calibration device.

According to further embodiments of the present invention, a process is provided that may include one or more steps, including:
i. clamping a dental implantation apparatus to a jawbone, wherein the dental implantation apparatus includes an outer frame having two arms each having a lower portion that extends along opposing sides of a jawbone, and the apparatus includes a plurality of cleats protruding from each arm of the outer frame, and the step of clamping the apparatus includes inserting and engaging a plurality of the cleats into gum tissue and/or into the bone;
ii. after clamping, attaching to the outer frame an inner frame including vertical cross members with attachable articulating arms;
iii. attaching to the articulating arms of the inner frame a platform for the insertion of one or more tools for preparing an osteotomy and/or for implanting a dental implant into a jawbone;
iv. adjusting the position of the platform relative to the jawbone after the apparatus has been attached to the jawbone; and
v. maintaining the position of the platform while performing one or more steps of preparing an osteotomy and/or implanting a dental implant.

In some embodiments, the step of adjusting the platform may include a step of adjusting one or any combinations of the following:
i. adjusting the buccal to lingual position of the platform;
ii. adjusting the tilt angle of at least a portion of the platform relative to the vertical axis;
iii. adjusting the anterior to posterior position of the platform; and/or
iv. adjusting the direction of the projection of the tilt angle of the at least a portion of the platform onto the plane perpendicular to the vertical axis.

In still further embodiments, the implanting apparatus may include at least one of the following:
(a) at least one of said platform and/or frames and/or arms being detachable from each other to enable sequential installation of the arms, frames and platform with respect to the bone;
(b) at least one of said frames and/or arms having an articulated joint for connection to at least part of the platform and being moveable towards and away from the platform;
(c) said guide bore being adapted to receive a snap-fit guide member wherein the position of the member is adjustable with respect to the guide bore; and
(d) at least one fixation cleat having a self-adjusting moveable tip coupled to a self-adjusting and moveable limiting face element.

In further embodiments, the bone is a jaw bone, and the procedure includes preparing a dental osteotomy and/or implanting a dental implant into a jaw bone.

In further embodiments, at least a portion of the platform includes one or more features for changing an angle of the platform relative to the bone, so that the apparatus can be used for preparing one or more dental osteotomies optionally having bores with different angles.

In further embodiments, at least a portion of the platform includes one or more features for changing the direction of an angle of the platform relative to the bone, so that the apparatus can be used for preparing one or more dental osteotomies having bores with different angles and different directions of each of these angles.

In further embodiments, the apparatus comprises an outer frame having at least two clamp arms and an inner frame connectable to the outer frame, the inner frame preferably having at least two support arms being connectable to the platform.

Preferably, the platform comprises a single platform connectable to the inner frame and wherein the opposing ends of the platform that connect to the inner frame are curved to allow swiveling of the platform within the frame. More preferably, the ends of the platform are curved in a convex form to match a concave form provided by the support arms of the inner frame.

In further embodiments, at least a portion of the platform includes one or more features for changing the effective drilling height of the platform relative to the bone, so that the apparatus can be used for preparing two osteotomies having bores of different depths. Preferably this is achieved by the position of a guide member for receiving a drill head, gauge or other tool for preparing an osteotomy and/or for implanting a dental implant in a jawbone, the guide member being adjustable within the bore of the platform. More preferably, the guide member is in the form of a hollow cylinder, the outer wall of which is provided with a series of fixed projections or teeth that can mate with a corresponding projection or tooth that is moveable into and out of the bore. The projection or tooth is moveable into and out of the bore to allow engagement with and disengagement from a projection or tooth of the guide member, respectively enabling locking and unlocking of the guide member with respect to the platform. Movement of the tooth or projection into the bore is preferably by means of a slide mechanism.

In further embodiments, the guide bore may receive an orientation member in place of the guide member for assisting in the positioning of the platform with respect to the frame Preferably, the orientation member comprises a cylindrical head with a cut-out for receipt within the bore, the head having a shaft extending therefrom comprising a handle for orientating the platform with respect to the frame and also providing a visual marker to evaluate the angle and direction (guide path) of proposed drilling, or respectively, the orientation member incorporates a center bore so that a drill bit may be inserted therein and the drill bit's shank utilized as a handle in a similar fashion as the shaft extending from the head of the member as described above.

In further embodiments, the clamp arms of the outer frame have an upper region that extend above the crestal height of the jawbone and the occlusal plane of the teeth, wherein the upper region of the arms have a plurality of bore holes and are connected by one or more arm connection screws extending through a bore hole of each arm and by one or more arm guide pins extending through a bore hole of each arm, wherein the bore holes are aligned so that the arms are maintained in a generally parallel relationship.

In further embodiments, the platform is connected to a detachable inner frame, the inner frame has an upper portion, wherein the upper portion of the inner frame has a connecting arm having a cut out on its undersurface for receiving the clamp arm guide pins and the clamp arm connection screw, wherein the connecting arm of the upper portion of the inner frame has one or more features for securing and detaching the inner frame in a fixed position relative to the clamp arm connection screw and the clamp arm guide pins.

In further embodiments, the inner frame has a lower portion comprising parallel support arms that are connectable to opposing ends of the platform, each support arm being articulated with respect to the platform. Preferably, a locking screw and, optionally, a locking spring, may attach the articulated arm to the platform.

In further embodiments, the clamp arm connection screw is a right/left threaded screw so that both of the clamp arms of the outer frame can be simultaneously and/or equally moved towards or away from the inner frame and platform in a linear manner.

In further embodiments, the apparatus includes one or more screws for positioning and locking the platform in the anterior to posterior axis relative to the inner frame, relative to the outer frame, or both. The platform may be sprung-mounted with respect to the inner frame.

In further embodiments, the apparatus is sufficiently adjustable so that it can be used for implanting implants in a plurality of patients.

In further embodiments, the apparatus is formed of materials capable of being sterilized after use in preparing an osteotomy so that the apparatus can be employed in an osteotomy for a different patient.

In further embodiments, each clamp arm of the outer frame has internally threaded bore holes located at different heights and positions of each of the clamp arms for the insertion of each of the cleats so that the each of the cleats can be screwed individually into its clamp arm threaded bore position such that each of the cleat tips further variably penetrate into the gum depending upon the depth they are screwed in, and the arm connection screw has a knob for screwing the arms together so that the cleats can evenly penetrate the gum tissue and/or the bone independent of the curvature of the gum tissue and/or bone and the location of each cleat in its clamp arm bore. Each cleat may have a cleat tip that is moveable with respect to the main body of the cleat, preferably having a cleat tip that swivels freely in all directions so that when the cleats are individually engaged the coupled limiting face element of each cleat swivels as well so as to align itself parallel to the gum tissue overlying the jawbone plate that it is penetrating at its position in the clamp arms.

In further embodiments, the apparatus is capable of preparing a vertical osteotomy and is also capable of preparing an osteotomy at an angle of about 1° or more from the vertical axis.

In further embodiments, the apparatus is capable of preparing an osteotomy at an angle of about 1° or more from the vertical axis and in a full 360° directional arc of the horizontal axis.

According to some embodiments, a process is provided that comprises the steps of: clamping a dental implantation apparatus to a jawbone, preferably being a dental implantation apparatus as hereinbefore described, wherein the dental implantation apparatus includes an outer frame having two clamp arms each having a lower portion that extends along opposing sides of a jawbone, and the apparatus includes a plurality of cleats protruding from each clamp arm of the frame, and the step of clamping the apparatus includes inserting and engaging the each one of the cleats individually into gum tissue and/or into the bone; after clamping, attaching to the frame a platform for guiding one or more tools for preparing an osteotomy and/or for implanting a dental implant into a jawbone; adjusting the position of the platform relative to the jawbone after the apparatus has been attached to the jawbone; and maintaining the position of the platform while performing one or more steps of preparing an osteotomy and/or implanting a dental implant.

More preferably, after clamping, an inner frame is attached to the outer frame and the inner frame is secured to the platform.

According to some embodiments, the step of adjusting includes a step of adjusting one or any combinations of the following: a) adjusting the buccal to lingual position of the platform; b) adjusting the tilt angle of at least a portion of the platform relative to the vertical axis; c) adjusting the anterior to posterior position of the platform; or d) adjusting the direction of the projection of the tilt angle of the at least a portion of the platform onto the plane perpendicular to the vertical axis in a full 360° range of motion of the horizontal axis.

According to some embodiments, the process includes a step of measuring a distance between a portion of the platform and the crestal region of the jawbone for calibrating the depth for a step of preparing an osteotomy, wherein the step of measuring occurs after a step of adjusting the position of the platform.

According to some embodiments, the process includes a step of measuring the depth of an osteotomy (e.g., relative to a portion of the platform) for calibrating an insertion depth for inserting an implant, wherein the step of measuring a depth occurs after a step of adjusting the position of the platform.

According to some embodiments, the process comprises implanting an implant immediately following the extraction of a tooth, wherein the process includes one or any combination of the following steps: a) inserting an adjustable extraction socket gauge into a fresh extraction socket and measuring the depth of the socket; b) calibrating a calibration device utilizing a drill bit whose depth has been chosen based on a measured depth of the extraction socket; c) calibrating an implant driver and an adjustable drill guide gauge by inserting them into their appropriate slots in in the calibration device; d) clamping the outer frame over the extraction socket; e) adjusting the position and locking the inner frame and attached platform to the desired anterior/posterior and buccal/lingual position relative to the outer frame and the extraction socket; f) adjusting the platform of the dental implantation apparatus to a desired angular position using an orientation member as hereinbefore described inserted into the bore of the platform to determine a desired angle and/or a desired direction and locking the platform in this position; g) replacing the orientation member with a guide member attached to the calibrated drill guide gauge and pushing these down into the guide bore of the platform to determine a desired depth and locking the guide member at this depth within the bore by engagement of complementary teeth on the bore and guide member; h) removing the drill guide gauge and inserting the previously chosen drill bit length and/or bushing that was used to calibrate the calibration device into the locked guide member to prepare an osteotomy having or including a desired angle, a desired direction, a desired depth or any combination thereof; and/or i) inserting thereafter the calibrated implant driver into the guide member (e.g., a drill guide ring) and installing an implant into the now prepared osteotomy at a desired angle, a desired direction, a desired depth, or any combination thereof.

According to some embodiments, the process may be carried out for delayed placement of an implant and may further include one of the following steps: a) waiting for some or all of the socket to fill with bone following extraction of the tooth; b) calibrating a calibration device utilizing a drill bit whose drilling depth has been chosen based on diagnostic imaging of the target bone site; c) calibrating an implant driver and an adjustable drill guide gauge by inserting them into their appropriate slots in the calibration device; d) clamping the outer frame over the target bone site; e) adjusting the position and locking the inner frame and platform to the desired anterior/posterior and buccal/lingual position relative to the outer frame and the target bone site; f) adjusting the platform of the dental implantation apparatus to a desired angular position using an orientation member as hereinbefore described that has been inserted into the guide bore of the platform to determine a desired angle and/or a desired direction and locking the platform in this position; g) replacing the orientation member with a guide member attached to the calibrated drill guide gauge and pushing these down into the guide bore of the platform to determine a desired depth and locking the guide member at this depth within the bore by engagement of complementary teeth of the guide bore and member; h) inserting the calibrated drill guide gauge into the guide member, pushing down the drill guide gauge until its tip penetrates the gum and rests on the bone of the target implant site and locking the position of the guide member so that the guide member is locked and calibrated to drill to a desired depth, and removing the drill guide gauge from the guide member, so that the guide member is calibrated to drill to a desired drill depth independent of the thickness of the gum tissue overlying the bone of the target bone site; i) inserting one or more drill bits and/or bushings with a desired drill depth into the guide member for completing an osteotomy, wherein each provides a limiting flange when inserted into the guide member; and/or j) inserting a calibrated implant driver connected to an implant into the guide member, and screwing down the implant with an implant driver into the osteotomy, wherein the implant driver has a limiting flange for lying flush with a top surface of the guide member.

According to some embodiments, the process includes unclamping or otherwise removing the apparatus from the jawbone.

According to some embodiments, the process includes a step of sterilizing some or all of the apparatus and a step of using the sterilized components for implanting an implant in a different patient.

According to some embodiments, the process includes a step of preparing a second osteotomy at a different angle, a different direction, a different depth or any combination thereof from the first osteotomy in either the same patient or in a different patient, using the same apparatus (e.g., using the same platform).

According to some embodiments, a calibration device is provided that be used both for drilling an osteotomy having a predetermined depth, and or for inserting an implant into an osteotomy to a predetermined depth, the device comprising: an upper portion having at least one cut out extending from a top surface to a bottom surface of the upper portion for receiving one or more gauges or drill bits; a lower portion that is separate and spaced apart from the upper portion; each of the upper and lower portions having a bore, the bores being aligned between the upper and lower portions to receive a threaded shaft therethrough wherein the spacing between the top and bottom portion is adjustable by rotation of the shaft. Preferably, the threaded shaft is attached to a knob to impart rotation thereto. More preferably, at least one second bore is provided in each of the upper and lower portions spaced apart from the first for receiving a second non-threaded shaft that is freely slideable within this bore. The cutout of the upper portion may have a limiting step that acts as a limiting flange on either side of the cut out for inserting an adjustable drill guide gauge through the cut out and resting a limiting flange of the gauge on the limiting flange on either side of the cut out, wherein the spacing between the upper and lower portions is capable of being set by adjusting the spacing so that the adjustable lower tip of the gauge when inserted into the inner segment of the cut-out (for delayed implanting techniques) just touches the top surface of the lower portion and may be locked in this position. Alternatively, a drill bit of desired length is inserted into the front outer segment of the limiting flanges on either side of the cut out of the upper portion the calibration device, upper portion's position may be adjusted relative to the lower portion so that when the terminal cutting tip of the drill bit aligns with the calibration markings on the face of the lower portion the (pre-) calibration device is now calibrated to the desired drill depth. An adjustable drilling guide gauge or an adjustable and lockable implant driver may then be inserted into the front outer segment of the limiting flanges on either side of the cut out of the upper portion so as to align the gauge lower tip or drill bit lower tip against the face of the lower portion wherein the lower portion has calibration markings for calibrating the adjustable and lockable tip of the gauge or the adjustable and lockable implant driver; thereby enabling the calibration apparatus to be used for drilling an osteotomy (for the immediate implant technique) having a predetermined depth, and/or for inserting an implant into an osteotomy to a predetermined depth.

According to some embodiments, the device includes a cut out segment for receiving an adjustable inner element from a drill guide gauge, a cut out segment for receiving a series of drill bits with or without an attached bushing or an adjustable drill guide an adjustable shaft element of an implant driver.

According to some embodiments, a kit is provided that includes any combination of two or more of a clamping apparatus as hereinbefore described, an implant driver tool, a drill guide gauge, an extraction socket gauge, an orientation member or a calibration device as hereinbefore described.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIGS. 1A-1F are graphical illustrations of various components of the surgical clamp apparatus 1, according to some embodiments;

FIGS. 2A-2E are graphical illustrations of some of the components of the inner guide assembly main frame 12 of a surgical clamp apparatus 1, according to some embodiments;

FIGS. 3A-3D show different perspectives of graphical illustrations of the inner frame guide assembly 5 of the surgical clamp apparatus 1;

FIGS. 4A-4F are graphical illustrations of various elements of the swivel guide platform 3 and locking cylinder 4 and handle 10 related to the surgical clamp apparatus 1, according to some embodiments;

FIGS. 5A, 5B, 5E, 5F are graphical illustrations of the drilling guide gauge elements 25, according to some embodiments;

FIGS. 5C and 5D are graphical illustrations of swivel guide platform orientation elements 37 and 37a, according to some embodiments;

FIGS. 5G-5J are graphical illustrations of Guide Assembly locking screw elements 9 and 16, according to some embodiments;

FIGS. 5K-5L are graphical illustrations of right/left bolt elements 6, 7 and 8, according to some embodiments;

FIG. 6A is a graphical illustration of several drilling guide rings 15 adapted for use with a surgical implant clamping apparatus 1, according to some embodiments;

FIGS. 6B-6F and 7A are graphical illustrations of various calibration related components 30 adapted for use with a surgical clamp apparatus 1, according to some embodiments;

FIG. 7B is a graphical illustration of a drill bit bushing 24 adapted for use with a surgical implant clamping apparatus 1, according to some embodiments;

FIG. 7C is a graphical illustration of a drill bit 18 with bushing 24 adapted for use with a surgical clamp apparatus 1, according to some embodiments;

FIGS. 8A-8B are graphical illustrations of implant driver components 19 and implant 23, according to some embodiments;

FIG. 8C is a graphic illustration of a combined view of various implant clamp apparatus elements 1 as described above, according to some embodiments to which has been inserted an implant driver 19 and attached implant 23 component;

FIG. 8D is a graphic illustration of a guide ring 15, a drilling guide gauge element 25 and a guide ring 15 coupled to a drilling guide gauge element 25;

FIGS. 9A-9C are graphical illustrations of an extraction socket adjustable gauge holder 44 and adjustable gauge 35, according to some embodiments;

FIGS. 9D-9F are graphic illustrations of a clamp apparatus double ended hand tool 36, adapted for use with a surgical implant clamping apparatus 1, according to some embodiments;

FIGS. 10A-10G are graphical illustrations of various swivel cleat elements 11 adapted for use with a surgical clamp apparatus 1, according to some embodiments;

FIGS. 11A-11M are graphical illustrations of some of the steps of a setup for an immediate implantation treatment using a surgical clamp apparatus 1, according to some embodiments;

FIGS. 12A-12H are graphical illustrations of a some of the steps of the setup for a delayed surgical implantation treatment using a surgical clamp apparatus 1, according to some embodiments;

FIG. 13 is a flow chart that describes a series of operations or processes that may be implemented to prepare a jaw bone for delayed placement of a dental implant, according to some embodiments; and

FIG. 14 is a flow chart that describes a series of operations or processes that may be implemented to prepare a jaw bone for immediate placement of a dental implant, according to some embodiments.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

Embodiments of the present invention enable dental implant treatments using one time or reusable compact surgical clamp apparatus and guidance system. In accordance with a preferred embodiment of the present invention, the implanting apparatus is designed to be compact enough to be placed on one side of the patient's jaw, and can guide the bone preparation and implanting of a single implant into the missing space of a single tooth, even where there are adjacent teeth both anterior and posterior to the missing tooth space.

Means and methods are herein provided for the preparation and insertion into bony tissue of standard implants, and for positioning the apparatus, for changing a position of the apparatus, for changing an angle of a component of the apparatus or any combination thereof, following the securing of the clamp apparatus to the bone and prior to the procedure, such that the bone/gum preparation and implant insertion may be conducted by a practitioner with precise guidance tools to enable enhanced accuracy and safety. According to some embodiments, the adjusting of the apparatus to a patient's jawbone may include adjusting the buccal to lingual position of a portion of the apparatus, adjusting the tilt angle of at least a portion of the apparatus relative to the vertical axis, adjusting the anterior to posterior position of a portion of the apparatus; and/or adjusting the direction of the projection of the tilt angle and the degree of tilt angle from the vertical axis of the at least a portion of the platform onto the plane perpendicular to the vertical axis. In such dental implant treatments, whether for immediate or delayed surgical implantation treatments, the precision positioned and secured guidance system is able to provide the practitioner with the necessary depth, angle and direction of angle measurement to enable optimized and safe preparation and insertion of implants. Additional advantages provided by embodiments of the invention include easier installation and handling of the apparatus.

The clamp apparatus may come in several standard sizes so as to allow for matching a particular size clamp apparatus to better fit inside a particular patient's mouth and clamp properly to different sized jawbones.

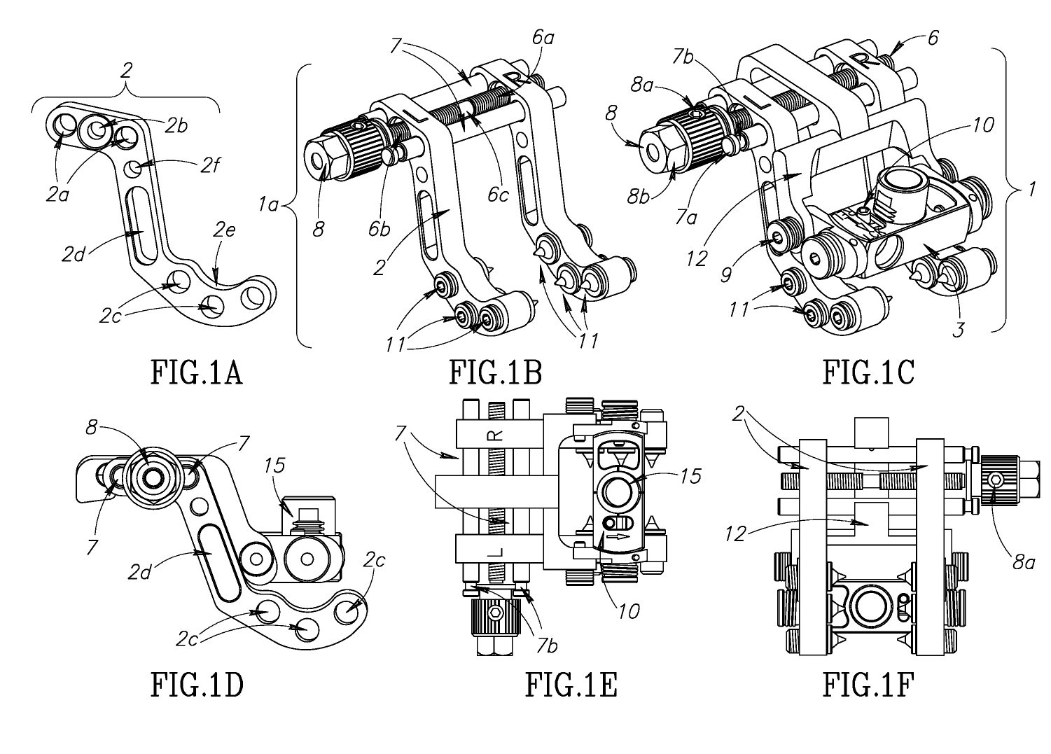

The surgical clamp apparatus described herein includes a number of improvements and/or modifications to the apparatus described in the Applicant's co-pending unpublished Application No. GB 1304950.7. FIGS. 1A-1F are graphical illustrations of various components of a surgical clamp apparatus 1, according to some embodiments. The surgical clamp apparatus 1 is fabricated from sturdy materials that are bio-compatible with living tissue and fluids can be cleaned and repeatedly sterilized using known methods in the field. These may include various metal alloys such as different types of stainless steel or different types of titanium or titanium alloys. These may also include various surgical grade plastic materials or other suitable materials.

As can be seen in FIGS. 1A-1B, surgical clamp arm(s) 2 include clamp arm bore holes 2a for guide pins 7, to enable temporary secured engagement of surgical clamp arms 2 to guide assembly main frame 12 (see below). Surgical clamp arm(s) 2 further include a clamp arm bore hole 2b for a right/left bolt 6, for enabling simultaneous widening or narrowing of the two clamp arms relative to each other in a linear manner, and locking at an optimal distance. Surgical clamp arm(s) 2 further include clamp arm bore holes 2c for surgical fixation swivel cleats 11 (described below), a clamp arm vertical portion with cut out 2d, and a curved clamp arm swivel cleat holder arm section 2e which allows for multiple cleat fixation of the bony plates (buccal and lingual) at several different heights and locations.

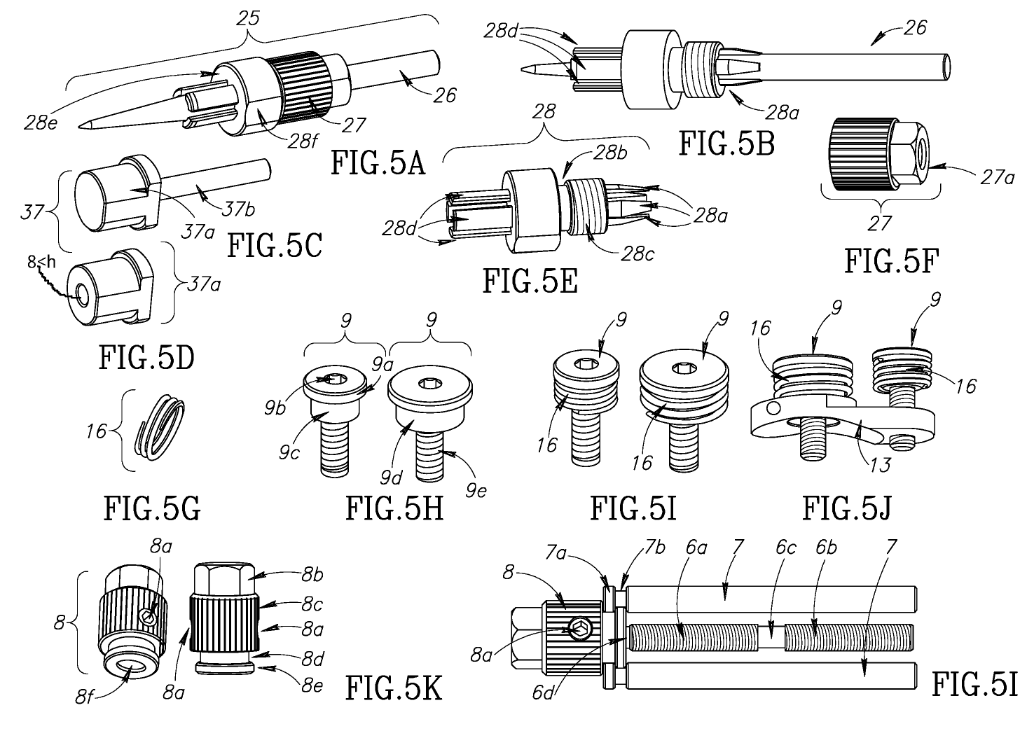

As can be further seen in the figures, Right/Left threaded bolt 6 includes Right section of Right/Left bolt 6a, Left section of Right/Left bolt 6b, Right/Left unthreaded bolt center section 6c, and Right/Left threaded bolt oval terminal end 6d. Guide pins 7 include guide pin head 7a, and guide pin notch 7b, to allow for linear smooth opening and closing movement of the two clamp arms and simultaneous clamping and de-clamping of both the buccal and lingual bony jaw plates. The Right/Left bolt 6, as can be seen in FIGS. 1B-1F and further in FIGS. 5K and 5L, may include Right/Left bolt set screw and bore 8a, Right/Left bolt knob hex driver tool head 8b, Right/Left bolt knob knurled handle 8c, Right/Left bolt knob guide pin notch 8d, Right/Left bolt knob guide pin limiting ring 8e, and Right/Left bolt knob oval bore 8f for insertion of oval terminal end of Right/Left bolt 6 terminal end.

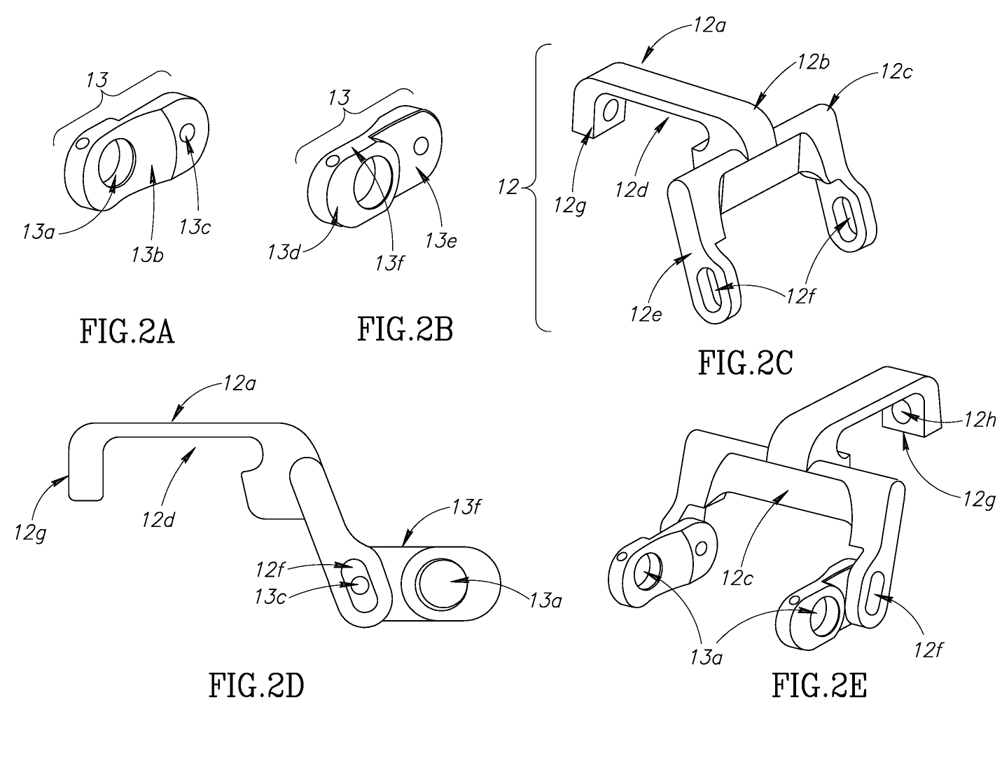

FIG. 1C is a graphical illustration of the surgical clamp apparatus 1 which may have connected to it a rotatable swivel platform 3 suitable for being positioned over a bone and securely maintained in position for a procedure including preparing a bone for an implant and/or implanting an implant into said prepared bone. The rotatable swivel platform has a central guide bore therethrough and a compact design to enable easier access to the highly restrictive target bone site. The platform 3 is coupled to a guide assembly main frame 12 comprising two support arms linked by a connecting arm, which itself couples with right and left articulating guide assembly arms 13 (see FIGS. 2A, 2B, 2C, 2D and 2E), where both arms are coupled to the guide assembly main frame 12 that is attachable and secured to the surgical clamp apparatus outer frame 1a, which itself is connected by a right/left threaded bolt 6 and guide pins 7, to enable the two clamp arms 2 to be linearly closed and opened simultaneously and optionally to the same degree along the buccal to lingual axis. The outer frame 1a may be clamped in the mouth independent of the inner frame assembly 5 so as to increase visibility and aid in ease of initial positioning of the outer frame 1a at the target bone site, by enabling the inner frame to be separately attached and detached to/from the clamped outer frame, to facilitate sequential attachment of the outer and inner frame with respect to the bone. In some embodiments, the upper segment of each clamp arm 2 contains three bore holes where the two outer ones 2a are smooth and the center bore hole 2b is internally threaded. The two outer bore holes 2a are machined to allow for the insertion of a guide pin 7 into each bore hole 2a. The center bore hole 2b is machined to allow for the insertion of a right/left threaded bolt 6 with a knurled knob 8 attached on one of its ends. It will be appreciated that the center right/left threaded bolt 6 will be inserted so that the right directional threads of the bolt insert into the center bore hole 2b of the right clamp arm 2 and the left directional threads of the bolt insert into the center bore hole 2b of the left clamp arm 2.

Such an assembly of the above parts allows for the two clamp arms 2 to be linearly closed and opened simultaneously (brought closer to or further from each other) in a substantially symmetrically even manner when the knurled knob 8 (with its two locking nuts 8a) is turned either clockwise or counter-clockwise. To further enhance this symmetrically even opening/closing mechanism the two outer guide pins 7 have limiting heads 7a which face and engage a circumferential groove 8d on the knurled knob 8 attached to the center right/left threaded bolt 6.

The relatively vertical segment of each clamp arm 2 may contain an internally threaded bore hole 2f for the insertion of a set screw with a knob (not illustrated) that allows for the fine adjustment along the buccal to lingual axis (cheek to tongue) of the inner frame 12 when the inner frame 12 is attached to the outer frame 1a. The lower horizontal segment 2e of each clamp arm 2 may contain multiple internally threaded bore holes 2c which may be positioned in various positions relative to each other in this clamp arm segment.

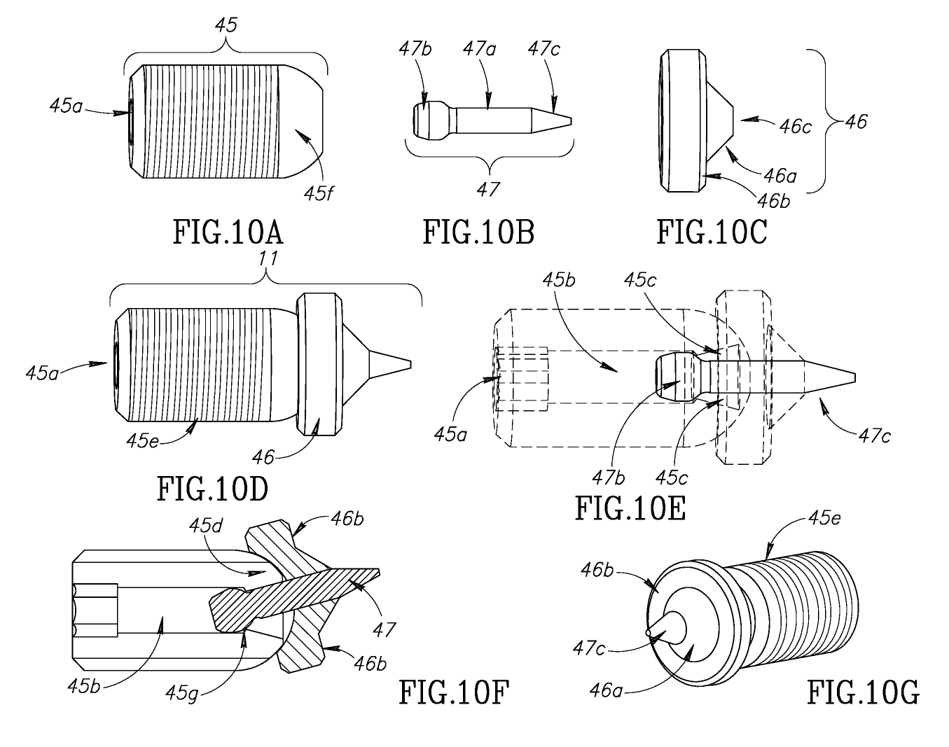

Each clamp arm 2 may include one or more fixation swivel cleats 11 with tips and coupled limiting faces that self-adjust to align to and penetrate into a bone and/or gum tissue on the opposing sides of the extraction socket or target bone site, so that the frame is firmly secured to the varying gum/bone morphology of different patients during each individual patient's procedure (see FIGS. 10 below). The ability for automatic alignment of the swivel cleats to the curvature of the jaw bone provides a more controlled and directed engagement of the clamp arms to the bone. The multiple internally threaded bore holes 2c of the clamp arms 2 described above accept the insertion of variously designed individually adjustable fixation cleats 11 whose pointed tips 47c (of various shaped design) engage and penetrate a short distance either directly into the side bony walls (buccal and lingual plates) of the alveolar ridges or through both the gums tissue overlying the ridges and the bony ridges when the clamp arms 2 are tightened towards each other, by rotating the knurled knob 8 that is secured to the center right/left bolt 6, thereby stabilizing and securing the surgical clamp apparatus 1 at multiple locations on both the buccal and lingual aspects of the patient's gums and/or jawbone. The cleats may be individually adjusted to further engage or disengage the gum and or bone by using a hex driver tool inserted into the hex socket 45a (see FIGS. 10 below) of each fixation cleat 11 so as to screw the threaded body 45 of each fixation cleat 11 through the threaded bores 2c of the clamp arms 2.

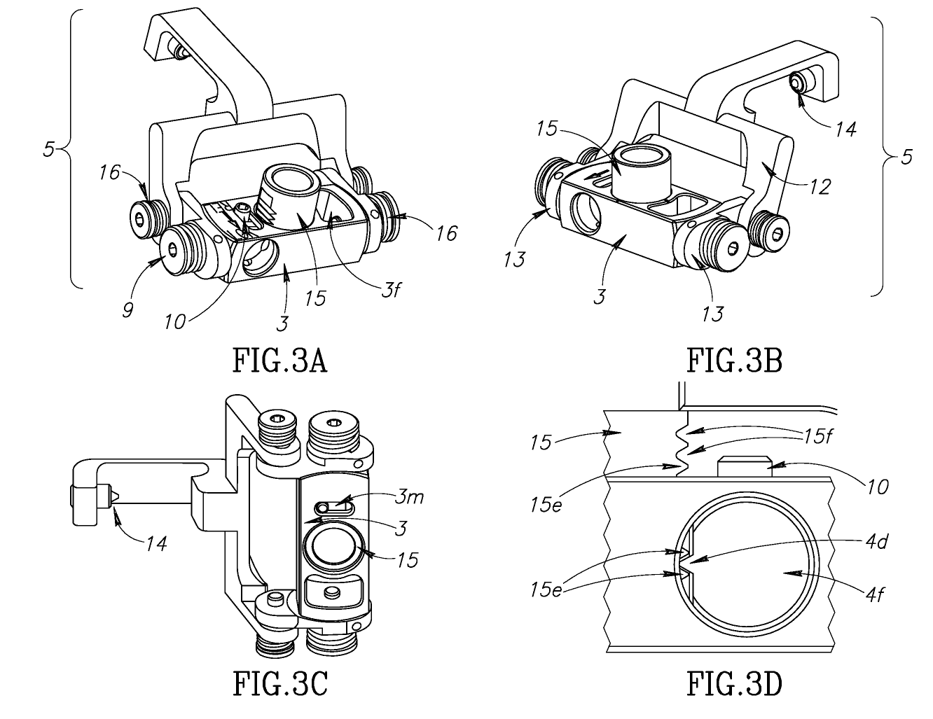

FIGS. 2A-2B are graphic illustrations of the inner frame guide assembly articulating support arms 13, for enabling fine articulation of guide assembly main frame angle and depth relative to the target procedure area. The provision of articulating arms that are detachable from the inner frame support arms 12 provides enhanced movement to enable fine adjustment of the arms and platform, in both the anterior and posterior direction as well as up and down. Articulating arms 13 may include a distal arm bore 13a and mesial arm bore 13c into which are inserted the various guide assembly locking screws 9 with locking screw springs 16 (see FIG. 3A), the concave inner arm surface 13b to which is coupled the rotating swivel guide platform 3, so as to allow for rotating swiveling movement of the swivel platform within the concave inner arm surfaces 13b of articulating arms 13, the distal convex outer arm surface 13d, the mesial outer arm surface 13e, and the top arm surface 13f. Further, as can be seen with reference to FIGS. 2A-2B, a guide assembly articulating arm 13 may be attached to guide assembly main frame oval bore 12f by inserting the locking screws 9 and locking screw springs 16 wherein the oval bore 12f allows for superior/inferior and anterior/posterior movement of the articulating arms 13 to the inner frame main assembly 12 when it is coupled to said inner frame 12.

FIGS. 2C-2E show different perspectives and aspects of the guide assembly main frame 12 and articulating arms 13 of a surgical implant clamping apparatus 1, according to some embodiments. As can be seen in FIG. 2D, main guide frame 12 may include a guide assembly main frame attachment section top surface 12a, a guide assembly main frame cross-member connecting section 12b, a guide assembly main frame horizontal cross-member 12c, a guide assembly main frame attachment section inner surface 12d which rests on the guide pins 7 and the right/left bolt 6. A guide assembly main frame vertical cross-member 12e, and a guide assembly main frame oval bore 12f for attaching to the adjustable articulating arms 13. Guide assembly main frame attachment section top surface 12a may include a guide assembly main frame attachment section mesial limiting element 12g, and a guide assembly main frame attachment mesial limiting element bore 12h for the insertion of the guide assembly attachment screw 14 so as to secure the guide assembly main frame 12 to the surgical clamp outer frame 1a. The guide assembly main frame 12 may be assembled onto the two guide pins 7 and right/left threaded bolt 6 between the right and left clamp arms 2 of the outer frame 1a.

In some embodiments, guide assembly main frame 12 may have a horizontal and vertical segment in the shape of a “t” bar emerging from its upper horizontal segment which extends to the inner borders of both the right and left clamp arms 2. In some embodiments, the guide assembly main frame 12 when coupled with the two adjustable guide assembly articulating arms 13 serve as an outer frame for the insertion and securing of the swivel guide platform 3 and guidance position locking mechanisms so as to comprise the inner frame guide assembly 5. In some embodiments, the center right/left threaded bolt 6 may contain two spring coils (not shown) around its respective right and left threaded segments 6a and 6b (between either side of the inner frame 5 and the right or left clamp arms 2) to create a spring-loaded action to the movement of the inner frame 5 along the guide pins 7 and threaded bolt 6.

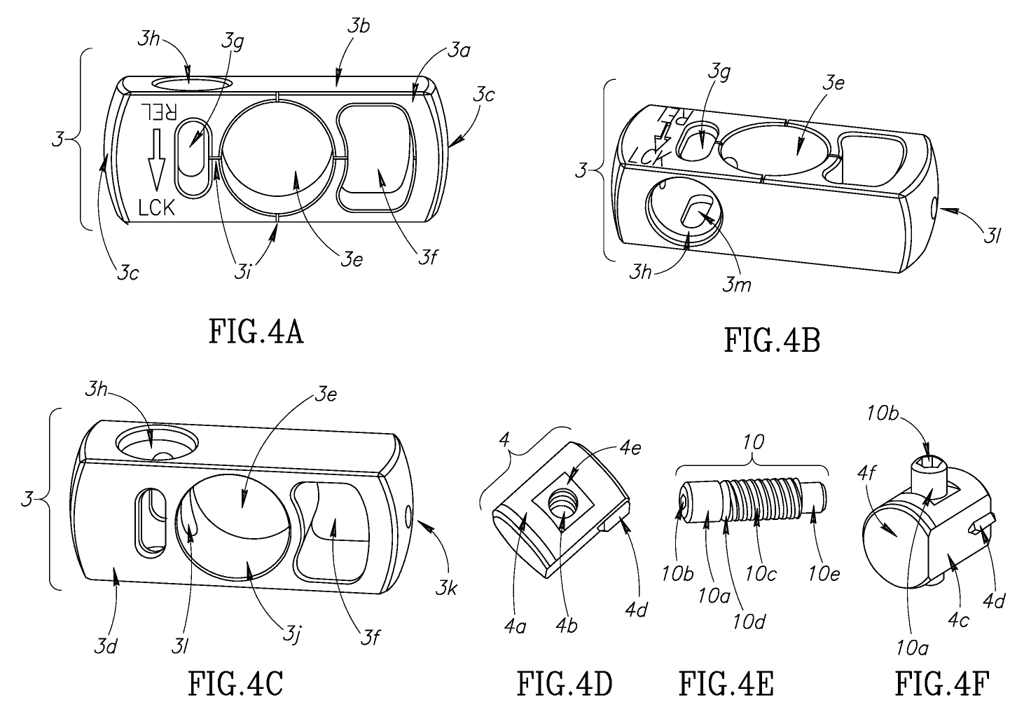

FIGS. 3A-3C show different perspectives of graphical illustrations of an inner frame guide assembly 5, which includes swivel guide platform 3 engaged with main guide frame 12 that has attached to it the right and left adjustable articulating arms 13, using guide assembly locking screw 9(s) and locking screw spring(s) 16, optionally used to enable stiffening of the screws prior to substantial tightening, at connection point of guide assembly articulating arms 13, to create a tension to hold and maintain the articulating arms 13 and the swivel guide platform 3 in a relatively static position prior to locking this position securely by tightening all the locking screws 9. As can be seen in the figures, swivel guide platform 3 includes swivel guide platform upper slot 3g (see FIG. 4A below) and lower slot 3m (see FIGS. 3C and 4B below) for guiding the locking cylinder handle 10 and swivel guide platform side bore 3f, and a swivel guide platform center bore 3e (see FIGS. 4) to facilitate engagement of a guide member in the form of a drilling guide ring 15. In some embodiments swivel guide platform 3 may be substantially a single plate where each of its ends (right and left) is spherical (e.g., half ball shaped) to enable swiveling or rotating. The ability of the whole platform to swivel provides for enhanced manipulation of the platform and allows for a safer locking mechanism.

FIG. 3D further shows the drilling guide ring 15, the swivel platform 3 and the locking cylinder 4 with handle 10 in greater zoom, including drilling guide ring projecting teeth 15e and drilling guide ring notches 15f of projecting teeth 15e. Further seen are matching components guide ring locking cylinder vertical engagement tooth 4d and guide ring locking cylinder body 4f. In some embodiments, center guide ring 15 may be locked using machined notches 15f to catch the locking cylinder tooth 4d in place, for determining a vertical limit of the drill guide ring 15, as well as for limiting the vertical limit of the bushing 24 of the drill bit 18. The use of an easily attachable and detachable guide ring with a non-threaded inner wall also allows for a larger bore hole thereby enabling drilling to a larger/wider size and better visibility for the operator at the drilling site.

FIGS. 4A-4C are graphical illustrations of some components of a swivel guide platform 3 of a surgical implant clamping apparatus 1, according to some embodiments. As can be seen in the figures, the swivel guide platform 3 may include a swivel guide platform top surface 3a, a swivel guide platform flat side surface 3b, swivel guide platform convex side surfaces 3c, a swivel guide platform bottom surface 3d, a swivel guide platform center bore 3e, a swivel guide platform cut out side bore 3f, a swivel guide platform upper slot 3g and lower slot 3m for locking cylinder handle 10, a swivel guide platform side wall bore 3h for sliding the locking cylinder 4 through, swivel guide platform alignment markings 3i, a swivel guide platform center bore side wall 3j for the secure insertion of the drill guide ring 15, a swivel guide platform convex side wall locking bore 3k, a swivel guide platform center bore side cut out 31 for locking cylinder tooth 4d, and a swivel suide platform upper slot 3g and lower slot 3m for guiding the sliding of the locking cylinder handle 10.

FIG. 4D shows a guide ring locking cylinder 4, which may include a guide ring locking cylinder top surface 4a, a guide ring locking cylinder bore 4b for locking cylinder handle 10, a guide ring locking cylinder side wall 4c, a guide ring locking cylinder vertical engagement tooth 4d, and a guide ring locking cylinder top surface cut out for threaded bore 4e which receives the threaded portion 10c (See FIG. 4E below) of the locking cylinder handle 10.

FIG. 4E shows a locking cylinder handle 10, which may include locking cylinder handle head 10a, a locking cylinder handle head socket 10b, a locking cylinder handle threaded screw shaft 10c for engaging the threaded bore 4b of the locking cylinder 4, a locking cylinder handle head limiting flange 10d for swivel guide platform upper slot 3g, and a locking cylinder handle guide pin 10e for swivel guide platform lower slot 3m.

FIG. 4F shows locking cylinder handle head socket 10b and head 10a sitting above the engaged guide ring locking cylinder body 4f. The hand tool 36 engages the cylinder handle socket 10a to slide the handle and attached cylinder body 4f through the platform side wall bore 3h.

FIGS. 5A, 5B, 5E, 5F are graphical illustrations of the drilling guide gauge 25 elements, according to some embodiments. Drilling gauge 25 is designed to enable measuring of an optimal depth and angle for the drilling procedure, and for securing a safety limit for the drilling procedure. As can be seen in the figures, an Adjustable drilling guide gauge 25 may include an adjustable drilling guide gauge inner shaft probe element 26, an adjustable drilling guide gauge locking nut 27, an adjustable drilling guide gauge locking nut threaded bore 27a, and an adjustable drilling guide gauge collet 28. Further, the adjustable drilling guide gauge collet 28 may include multiple adjustable drilling guide gauge collet clamping prongs 28a, and adjustable drilling guide gauge collet limiting flange 28b, an adjustable drilling guide gauge collet threaded section 28c for engaging locking nut 27, and multiple adjustable drilling guide gauge collet inner shaft clamping prongs 28d to whose limiting flange 28e may securely be clipped the drill guide ring 15.

FIG. 5C is a graphical illustration of swivel guide platform orientation elements 37, according to some embodiments, to help aid visually to establish an optimal angle and direction of angle for drilling, and enabling the swivel platform to be oriented at the selected angle and direction of angle for drilling. As can be seen in the figures, swivel guide platform orientation element 37a may include swivel guide platform orientation element base 37a with a bore 37c therethrough for insertion of a drill bit 18 (which may then be inserted through the bore and into an extraction socket and acts to guide both as a handle to adjust the orientation base element 37a and guide its desired position when the drill bit terminal cutting end is engaged in the extraction socket) and swivel guide platform orientation element 37 with integrated orienting pin 37b which acts as a handle to adjust the position of the orientation element 37. The swivel guide orientation element is used prior to insertion of the drill guide ring by placing it in the drill bore with the flat side towards the locking mechanism. The pin 37b or alternatively, the shaft of the drill bit 18 extending above the orientation element base 37a allows visual orientation of the platform which can then be locked in the required position.

FIGS. 5G-5J are graphical illustrations of guide assembly locking screw elements, according to some embodiments. As can be seen in FIG. 5G, a locking screw spring 16 is provided to help provide initial tension to aid securing of guide assembly locking screws 9. As can be seen in FIGS. 5H-51, guide assembly locking screw 9 may include guide assembly locking screw head 9a, guide assembly locking screw head socket 9b, guide assembly locking screw neck 9c, guide assembly locking screw limiting flange 9d, and guide assembly locking screw threaded shaft 9e. As can be seen in FIG. 5J, a pair of guide assembly locking screw(s) 9 are engaged in conjunction with locking screw springs 16 with guide assembly articulating arms 13, making use of locking screw springs 16 to enable initial stiffening of the locking screw elements in their initial position, prior to final tightening or locking of the screws 9. Further, a second pair of guide assembly locking screws 9 are engaged with right and left locking bores 3k of the swivel guide platform 3, making use of locking screw springs 16 as described above to enable initial stiffening of the locking screw elements in their initial position, prior to tightening or locking of the screws 9.

FIGS. 5K-5L are graphical illustrations in greater zoom of the knurled knob 8 and the outer frame guide pins 7 and left/right threaded bolt 6 wherein are depicted the knurled knob 8, the oval bore 8f of the knurled knob 8 which engages the terminal end 6d of the left/right bolt 6 and which secured the terminal end 6d with its two locking nuts 8a, the limiting heads 7a of the guide pins 7 which engage the circumferential groove 8d of the knurled knob 8 so as to allow for the smooth linear opening and closing of the clamp arms 2 of the outer frame 1a.

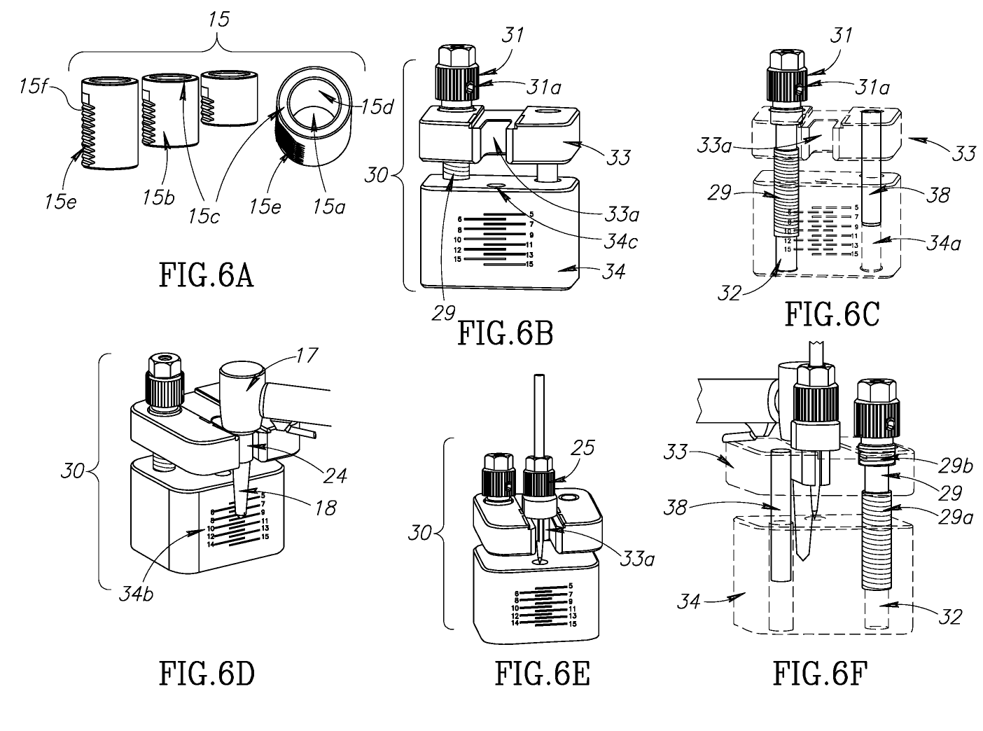

FIG. 6A is a graphical illustration of several drilling guide rings 15 adapted for use with a surgical clamp apparatus 1, according to some embodiments. As can be seen in the figures, drilling guide ring 15, which may be secured and locked to facilitate drilling to a selected depth, may include drilling guide ring bore 15a, drilling guide ring outer side wall 15b, drilling guide ring upper limiting flange 15c, drilling guide ring bore inner walls 15d, drilling guide ring projecting teeth 15e, and drilling guide ring notches 15f of projecting tooth 15e.

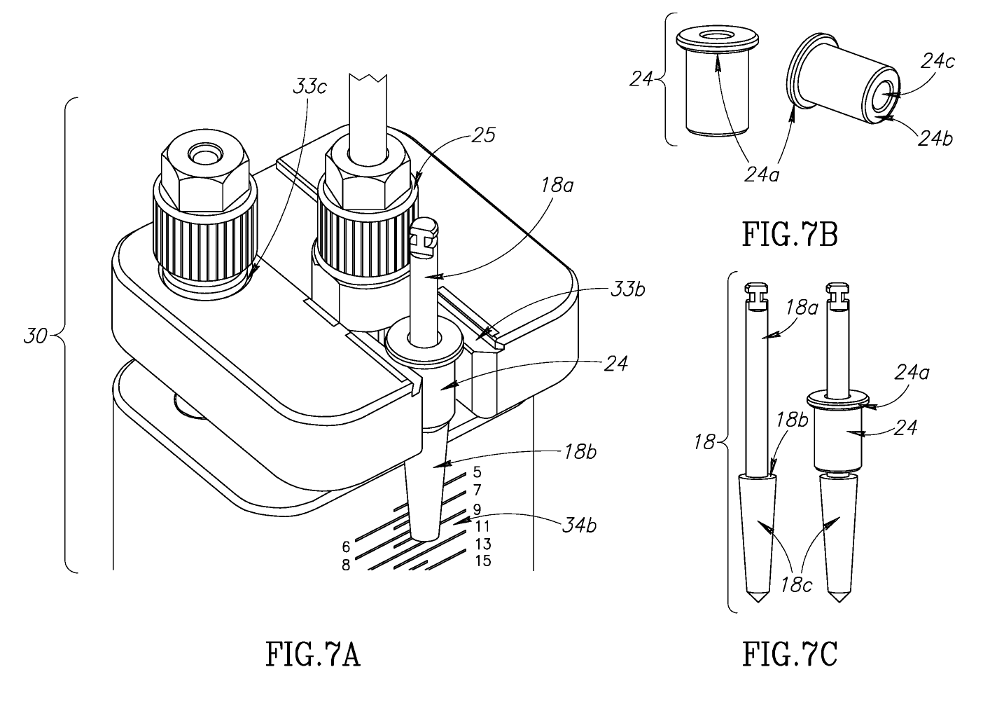

FIGS. 6B-6F and 7A are graphical illustrations of various calibration related components adapted for use with a surgical implant clamping apparatus 1, to facilitate accurate and secure drill depth setting in accordance with a measured or otherwise pre-determined optimal treatment plan, according to some embodiments. As can be seen in the figures, pre-calibrating device 30 may include a pre-calibrating device adjustable threaded guide bolt knob 31 integrating pre-calibrating device adjustable threaded guide bolt knob locking screw 31a which when turned in a clockwise or counter-clockwise manner respectively lifts or lowers the upper element 33 in respect to the lower element 34 by engaging the threaded guide pin 29 and turning it within its threaded bore shaft 32 while the unthreaded guide pin 38 slides through its unthreaded bore shaft 34a to stabilize this linear movement of the upper element 33. Further elements as can be seen may include pre-calibrating device top element 33, and pre-calibrating device bottom element 34. Pre-calibrating device upper element 33 may include pre-calibrating device upper element cut out for the adjustable implant driver 19, the drilling guide gauge 25 and drill bit 18 with bushing 24, pre-calibrating device upper element cut out limiting shelf 33b which holds in place the inner limiting flange 24a of the bushing 24 or alternatively the inner limiting flange 28e of the adjustable drilling guide gauge 25 or the limiting flange 22d of the adjustable implant driver 19, and pre-calibrating device threaded guide bolt bore 32. Pre-calibrating device may include sliding unthreaded guide pin 38. Pre-calibrating device bottom element 34 may include a pre-calibrating device unthreaded sliding guide pin shaft 34a, pre-calibrating device calibrating markings 34b of the lower element 34, and (FIG. 6E) a pre-calibrating device adjustable drilling guide gauge limiting bore 34c into which seats the tip of the inner sliding element 26 of the drill guide gauge 25 so as to calibrate the drill guide gauge 25, when the limiting flange 28e of the drilling guide gauge is seated in the upper element cut out limiting shelf 33b, to the varying thickness of the gum tissue overlying the alveolar crestal bone in the delayed surgical implantation technique in different patients.

As can further be seen, a pre-calibrating device adjustable threaded guide bolt 29 may be provided, which may include pre-calibrating device adjustable threaded guide bolt threaded shaft 29a and a pre-calibrating device adjustable threaded guide bolt spring 29b, where the spring acts to hold the adjusted position of the upper element 33 in respect to the lower element 34 of the pre-calibrating device 30.

Additionally shown in FIGS. 6D and 7A-7B, is an implant drill hand piece attachment 17, holding a drill bit 18, drill bit shank 18a, drill bit shank limiting flange 18b, and drill bit cutting end 18c, for calibrating the drill bit 18 inside the drill hand piece attachment 17. FIG. 7A depicts the positioning of the drill bit 18 with attached bushing 24 with its limiting flange 24a and the limiting flange element 28e of the drilling guide gauge 25 seated in the limiting shelf 33b of the cut out 33a of the pre-calibrating device 30. FIG. 7B illustrates the drill bit bushing 24, including rill bit bushing upper limiting flange 24a, which functions as a vertical stopper, drill bit bushing lower limiting flange 24b, and drill bit bushing bore 24c.

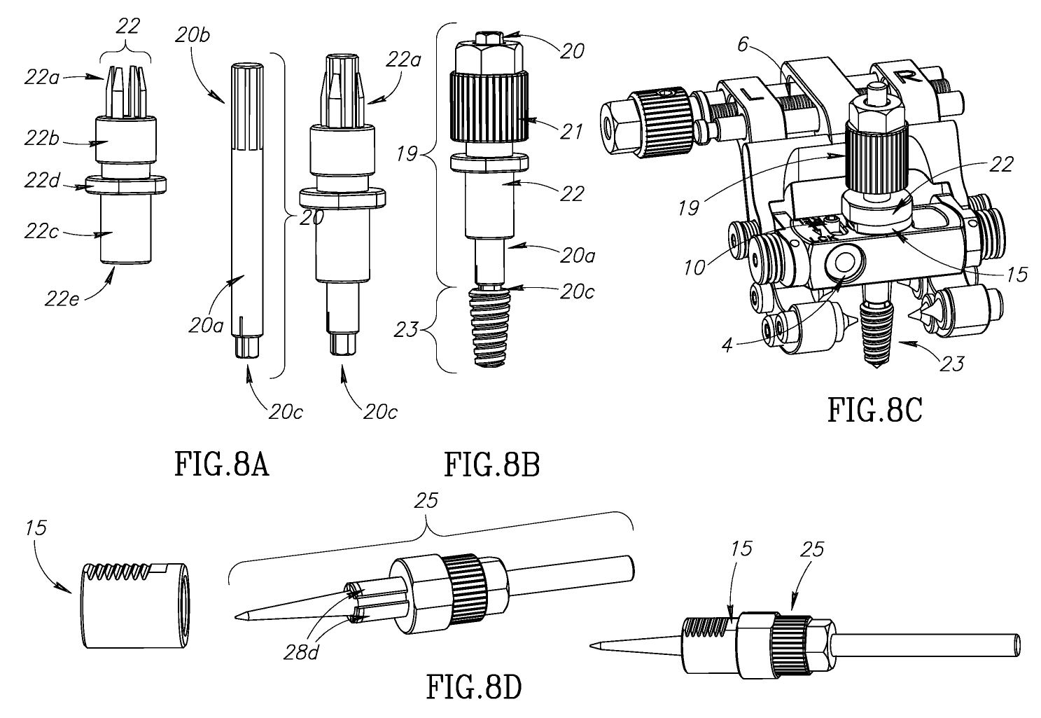

FIGS. 8A-8B are graphical illustrations of implant driver components, for securely engaging a selected implant 23 for implanting to a selected depth, according to some embodiments. As can be seen in the figures, an adjustable implant driver 19 is provided that may include an implant driver adjustable driver shaft element 20, an implant driver collet 22 and an example of a dental Implant 23. Adjustable implant driver 19 may further include an implant driver shaft main body 20a, an implant driver adjustable driver shaft top section 20b, an implant driver driving head 20c, and an implant driver locking nut 21. Implant driver collet 22 may include implant driver collet clamping prongs 22a for engaging driver shaft main body 20a, implant driver collet clamping prongs head 22b, implant driver collet shaft 22c, implant driver collet shaft limiting flange 22d, and implant driver collet shaft bore 22e.

FIG. 8C shows a graphical illustration of a surgical clamp apparatus 1 with many of the elements described above, and in particular, Right/Left threaded bolt 6, adjustable implant driver 19 with implant driver collet 22 inserted into drilling guide ring 15, guide ring locking cylinder 4, locking cylinder handle 10, and dental implant 23 attached to implant driver 19.

FIG. 8D illustrates the guide ring 15 coupling onto and secured to the guide ring clamping prongs 28d of the adjustable drilling guide gauge 25. The operator would attach these two components together and then place them into the swivel guide platform center bore 3e after the operator had calibrated the adjustable drilling guide gauge to the desired drilling depth on the pre-calibrating device 30.

In accordance with some embodiments, an apparatus and methods are herein provided to enable calibration of implant instruments outside the mouth of a patient, prior to the invasive treatment. For example, if a practitioner determines to use a drill bit set to 10 mm implant, calibration apparatus knob 31 may be turned to set the upper and lower apparatus elements to be set at the appropriate distance in accordance with the desired drill bit length when the drill bit with attached bushing is inserted into the pre-calibration device 30 and the tip of the drill bit aligns with the desired calibration marking (see FIG. 7A) on the lower element 34 of the pre-calibration device 30 so as to calibrate the calibration device for the calibration of other tools that will now be described.

In turn, other necessary tools, such as the adjustable implant driver 19 and adjustable drilling guide gauge 25 may be calibrated in accordance with the drill bit settings of the now calibrated pre-calibration device as described above. All such tools may be set at a desired length and locked by rotation of a locking nut, locking collet and shaft. For example in the delayed implantation surgical technique, the unlocked drilling guide gauge inner shaft 26 of the adjustable drilling guide gauge 25 may be inserted into the inner segment of the cut out slot 33a of the upper element 33 so that the drilling guide gauge's limiting flange 28e rests on the limiting shelf 33b and is oriented so that its right and left flat side walls 28f are positioned to be aligned with the side walls of the limiting shelf 33b. The unlocked drilling guide gauge inner shaft is then pushed down so that its tip rests in the shallow limiting bore 34c of the lower element 34 and the locking knob 27 is turned clockwise to engage the collet 28 of the drilling guide gauge 25 and so lock this position of the inner shaft 26 within the drill guide gauge 25 that rests within the calibrating device 30 based on the drill bit length that was previously used to set or calibrate the pre-calibration device for the preparation of the osteotomy to said desired drilling depth. The configured drilling guide gauge 25 may then be removed from the calibration tool, and the appropriate sized drilling guide ring 15 may be snapped onto it. The practitioner inserts the above configuration into the center bore 3e of the swivel guide platform 3 of the clamped surgical guide apparatus 1 which previously had been positioned over the target bone site using the orientation element 37. The practitioner then generally needs to push the locked center shaft probe 26 of the calibrated drilling guide gauge 25 down until s/he feels the point at which the shaft probe end penetrates through the gum and engages the bone so as to set the correct vertical position of the drill guide ring in relation to the alveolar crest of the target bone site while compensating for the varying thickness of the gum tissue in different patients and in different locations in the jaws of the same patient that overlies said alveolar crest. This new vertical position of the drilling guide ring 15 within the center bore 3e of the platform 3 can now be locked by the practitioner when s/he then inserts the hand tool locking cylinder handle end 36c of the double ended hand tool 36 into the upper slot 10c of the locking cylinder handle 10 and slides the guide ring locking cylinder 4 through the locking cylinder bore 3h of the swivel guide platform 3 until the vertical engagement tooth 4d of the locking cylinder 4 has fully engaged the corresponding notch 15f of the drill guide ring 15. The drill guide ring 15 is now locked and set to the depth for bone drilling to the predetermined depth desired (based on the previously chosen drill bit length) exclusive of the gum thickness depth overlying the bone. This method of calibrating the drill guide ring 15 allows for the practitioner to compensate for the variable gum thickness in each patient and to enable the drilling to a depth of 10 mm in jaw bone regardless of the thickness of the gum tissue overlying the bone at the specific chosen target implant site.

Alternatively, in the immediate implantation surgical technique, where the depth of the fresh extraction socket which has previously been measured utilizing the extraction socket gauge 35 and its attached holder 44, the drilling guide gauge 25 can be calibrated on the pre-calibration device 30 to a desired clinical implant depth value determined by the practitioner based on the previously measured depth of the fresh extraction socket with a chosen drill bit of a desired drilling length used in the same manner as described above for the delayed technique in order to calibrate the pre-calibration device 30; and then by placing the unlocked drilling guide gauge 25 into the outer segment of the upper element cut out 33a of the pre-calibration device 30 and orienting the drilling guide gauge 25 in the limiting shelf 33b as described above and then pushing the unlocked inner shaft element 26 down until its tip aligns with the previously determined marking length 34c and then locking this position of the inner shaft 26 of the drilling guide gauge 25 by tightening the knob 27. The drilling guide ring 15 is then snapped securely onto the now calibrated and locked drilling guide gauge 25 and the two assembled components are then inserted into the pre-positioned swivel guide platform center bore 3e (as described above) and pushed down to this pre-determined depth. The locking cylinder 4 is then engaged by the practitioner to the drill guide ring as previously described above and the drill guide ring 15 is now locked to the desired drilling depth.

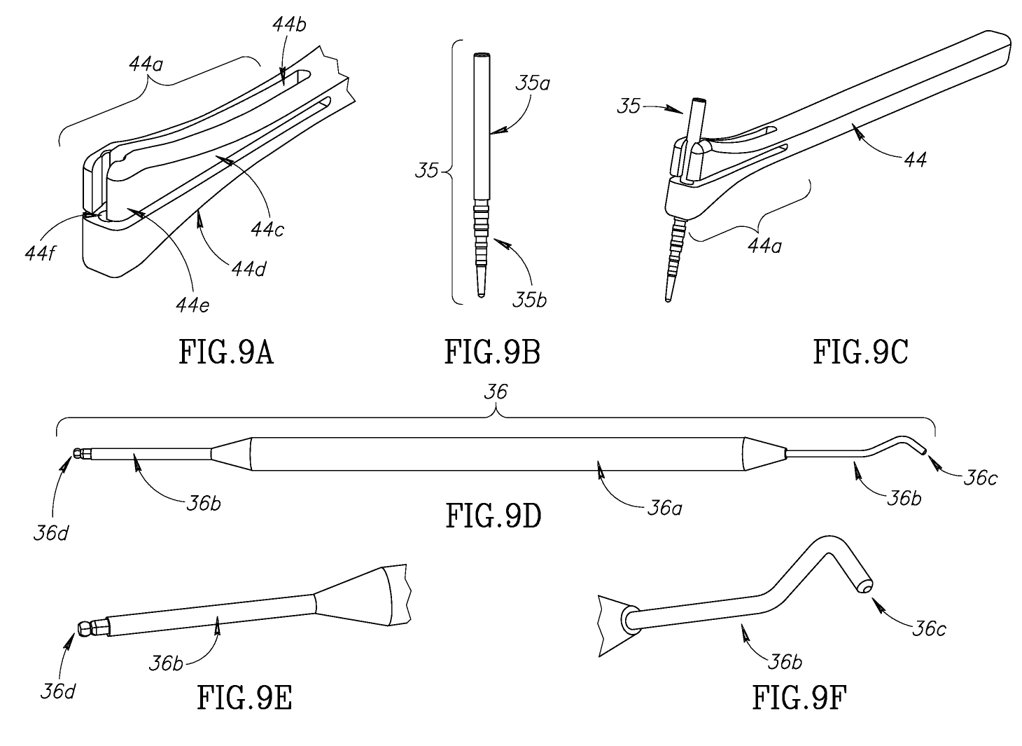

FIGS. 9A-9C are graphical illustrations of an extraction socket adjustable gauge holder 44 and adjustable extraction socket gauge 35, for helping determine an optimal drilling depth for a procedure, according to some embodiments. As can be seen in the FIG. 9A, an extraction socket adjustable gauge holder 44 is provided that may include an extraction socket adjustable gauge holder head 44a, and extraction socket adjustable gauge holder head vertical slit 44b, an extraction socket adjustable gauge holder head upper gripping element 44c, and extraction socket adjustable gauge holder head lower gripping element 44d, an extraction socket adjustable gauge holder head horizontal slit 44e, and an extraction socket adjustable gauge holder head bore 44f.

As can be seen in the FIG. 9B, an extraction socket adjustable gauge 35 is provided, that may include an extraction socket adjustable gauge shaft 35a and an extraction socket adjustable gauge measuring tip 35b. FIG. 9C shows the extraction socket adjustable gauge 35 engaged into extraction socket adjustable gauge holder 44.

FIGS. 9D-9F are graphic illustrations of an example of a clamp apparatus double ended hand tool 36, adapted for use with a surgical implant clamping apparatus, according to some embodiments. As can be seen in the figures, the clamp apparatus double ended hand tool 36 may include a clamp apparatus double ended hand tool handle 36a, a clamp apparatus double ended hand tool shaft section 36b, a clamp apparatus double ended hand tool locking cylinder handle end 36c, and a clamp apparatus double ended hand tool hex driver end 36d. Of course, other kinds and types of hand tools may be used.

FIGS. 10A-10F are graphical illustrations of various swivel or rotatable cleat elements 11 adapted for use with a surgical clamp apparatus 1, according to some embodiments. Such swivel cleats 11 may be used to enable positioning of the clamp apparatus in multiple orientations, positions, angles, tilts etc. to allow for optimal penetration in a target gum or bone site, for straight, curved, uneven and irregular surfaces of bone and or gums. As can be seen in the figures, a swivel cleat body 45 is provided, which may include a swivel cleat driver socket 45a, a swivel cleat internal bore 45b, a swivel cleat internal bore swivel section 45c, which functions as an area with a widened range for enabling swivel cleat fixation element 47 swiveling movement, a swivel cleat internal bore limiting flange 45g which further limits the swivel range of movement of the ball anchor 47b of the fixation element 47 in the swivel internal bore 45b, swivel cleat outer bore walls 45d, swivel cleat body outer threaded walls 45e, and swivel cleat body convex section 45f. Further, swivel cleat limiting face element 46 is provided, that may include a swivel cleat limiting face element gingival cone section 46a, a swivel cleat limiting face element flat ring section 46b, a swivel cleat limiting face element bore 46c, and a swivel cleat limiting face internal concave surface 46d where said limiting face element 46 swivels freely on the convex face 45f of the clear body 45 and self-aligns to the opposing gum/bone tissue when the fixation element tip 47c is engaged and penetrated the gum/bone tissue. Additionally, a swivel cleat fixation element 47 is provided, that may include a swivel cleat fixation element shaft 47a, a swivel cleat fixation element rotating ball end or ball type anchor 47b, forming a reverse ball-type socket, and a swivel cleat fixation element or penetrating tip 47c.

As can be seen in FIG. 10F, fixation cleat 45 may be positioned in multiple orientations, positions, angles, tilts etc. to allow for optimal placement in accordance with even curved, uneven and irregular surfaces of bone and or gums. In some embodiments, the internal bore swivel section 45c may be designed to enable movement of the cleat fixation element 47 and attached rotatable limiting face element 46 substantially up to 22.5 degrees in each direction, and optimally around 15 degrees in all directions. Actual angles of movement may be greater or lesser than described above, but may be optimally designed to allow freedom of movement in all directions, yet substantially maintaining the strength of fixation cleats and disallowing dis-alignment or weakening of the fixation cleat integrity.

FIG. 10G depicts a graphical illustration of a swivel or rotatable cleat body 11 adapted for use with a surgical clamp apparatus 1, according to some embodiments. As can be cleat body 45 may include outer threaded walls 45e, and may further include swivel cleat rotatable limiting face element gingival cone section 46a, swivel cleat limiting face element flat ring section 46b, and swivel cleat fixation element penetrating tip 47c.

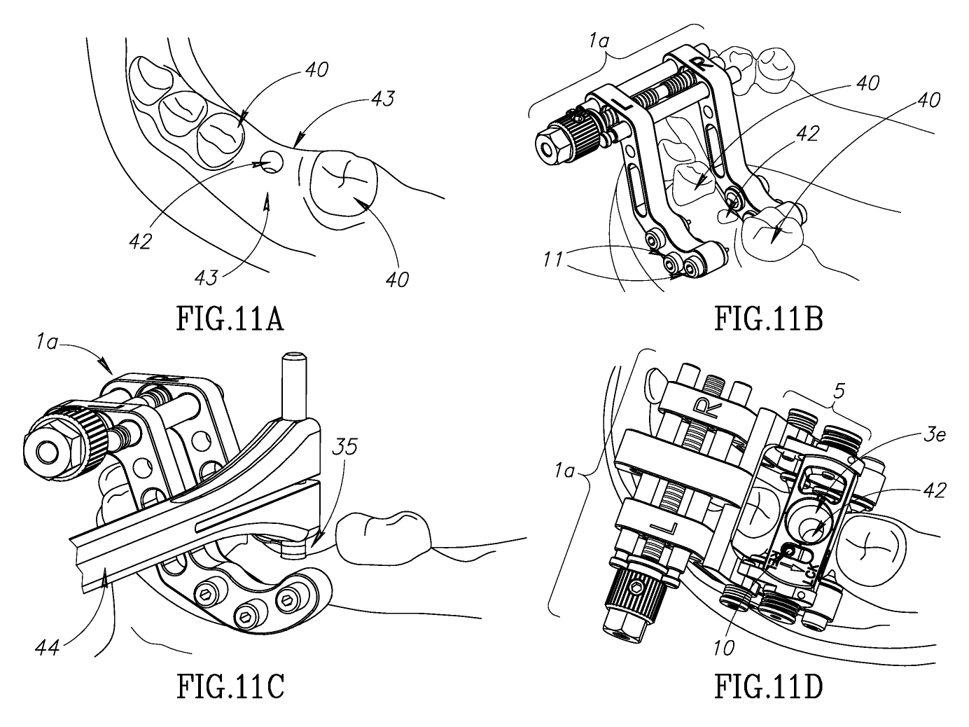

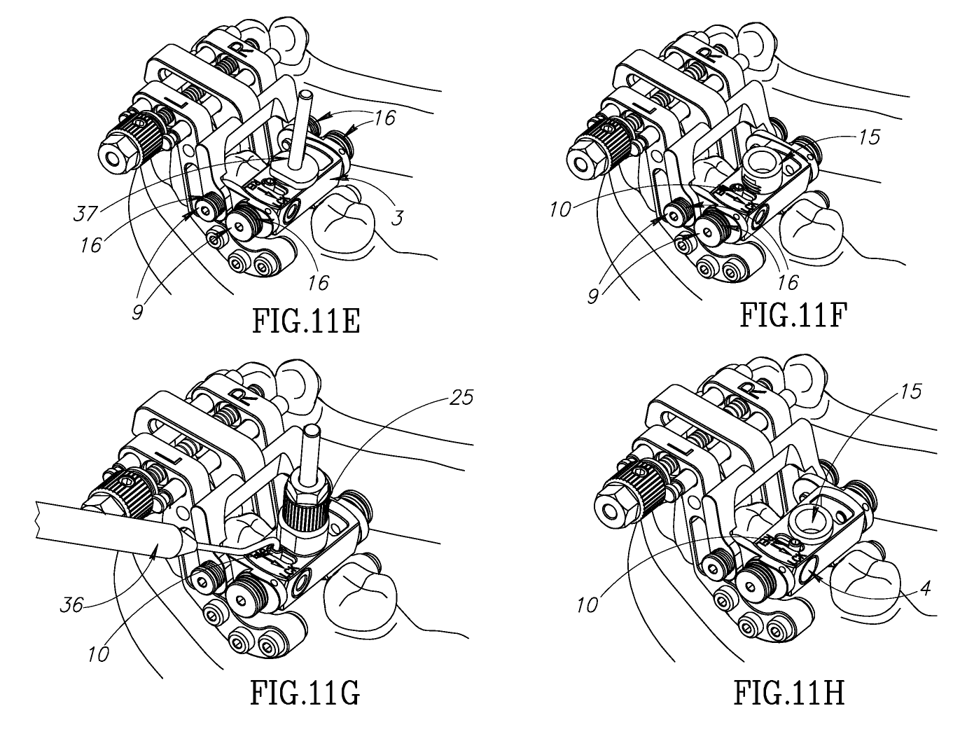

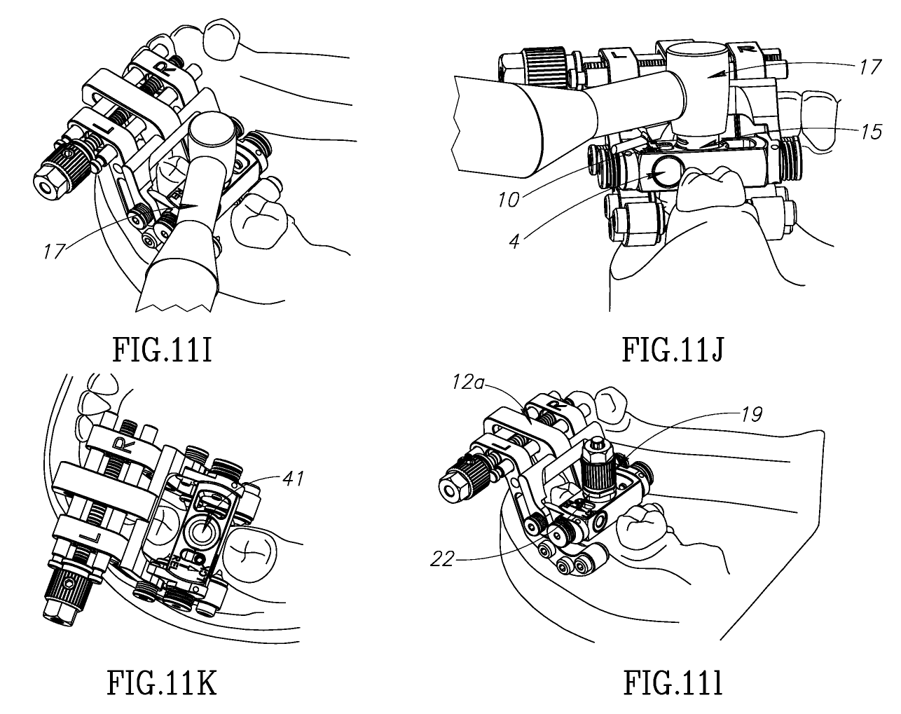

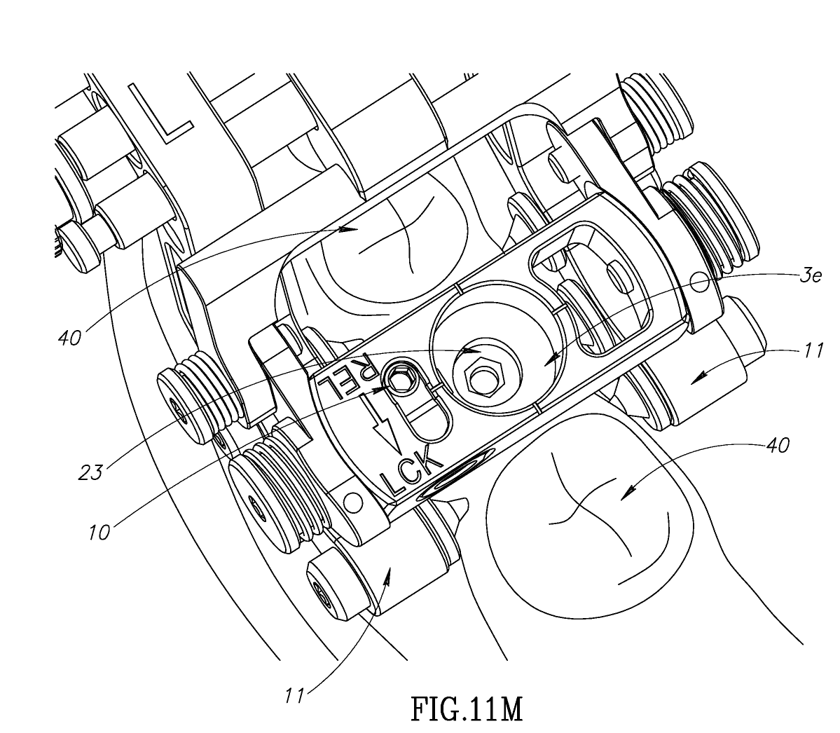

FIGS. 11A-11M are graphical illustrations of a setup for an immediate implantation treatment using a surgical implant clamping apparatus 1, according to some embodiments of the present invention. As can be seen, in FIG. 11A, following extraction of a tooth, the extraction socket 42 is located, between the teeth adjacent to the target bone site 40. Bony plates of the jaw covered by gum tissue are shown at 43.

In FIG. 11B the surgical clamp outer frame 1a is placed and attached over the extraction socket 42. At this stage the Right/Left threaded bolt 6 may be adjusted to align the clamp apparatus such that when closing the surgical clamp arms 2, they are substantially adjacent and aligned to the bony plates externally and internally of the extraction socket. Further, the multiple fixation cleats 11 may be tightened to individually engage securely with gum or bone sites, to secure clamp arms 2 in place. Especially where swivel cleats are used, the cleats will automatically adjust their rotatable limiting face elements and fixation elements to the contoured surfaces of both the buccal and lingual bony plates so as to fix the clamp arms securely onto the gums and underlying bone at multiple locations of both the buccal and lingual plates of the jawbone.

In FIG. 11C an extraction socket adjustable gauge holder 44, with an attached extraction socket adjustable gauge or measuring tip 35, with an adjustable shaft, is used to measure the depth of the extraction socket hole 42, and optionally to also to verify the angle, tilt etc. of the desired osteotomy preparation to be drilled for the insertion of the implant 23 into the completed osteotomy 41 (see FIG. 11k).

In FIG. 11D, the inner frame guide assembly 5 is attached and secured to the previously clamped surgical clamp outer frame 1a such that the now assembled surgical clamp apparatus 1 with swivel guide platform center bore 3e can be seen positioned directly over the extraction socket 42.

In FIG. 11E, the rotatable swivel guide platform 3 can be appropriately angled, tilted and otherwise oriented over the extraction socket hole, optionally utilizing an embodiment of the swivel guide platform orientation element 37, and then the platform may be locked into position with the locking screw/spring elements 9 and 16. As can be seen, the orientation element 37 can be inserted into the central bore 3e of the swivel guide platform to optionally be used as a joystick type measuring device enabling to help establish visually the optimal access drill path, including tilt, orientation and position of the swivel guide platform 3 for drilling, prior to locking this position with the locking screws and springs 9 and 16. The locking slide mechanism of the platform is easy and quick to apply and enables easy re-adjustment where necessary.

In FIG. 11F, the guide assembly locking screws 9 with their locking screw springs 16, can be tightened to keep the swivel guide platform optimally positioned. Further drill guide ring 15 may be placed in swivel guide platform center bore 3e or alternatively it may first be secured to the pre-calibrated drill guide gauge 25 as seen below in FIG. 11G The ability to add the drive ring to the bore after fixing the position of the platform provides greater visibility to the practitioner. The snap-on fitting of the guide ring and optionally guide gauge (see below) also provides enhanced locking and ease of use.

In FIG. 11G, the adjustable drilling guide gauge 25 with attached drill guide ring may be inserted into the swivel guide platform center bore 3e, and is pushed down till it reaches the calibrated depth that was previously set utilizing the pre-calibration device 30. The clamp apparatus double ended hand tool 36 or other small tool or even a practitioner's finger may be used to slide the locking cylinder handle 10 into lock position, thereby engaging guide ring locking cylinder 4 to the drill guide ring 15, to create a depth limiter that sets the drill guide ring 15 upper limiting circumferential flange height 15c and locking this position of the drill guide ring 15.

In FIG. 11H the adjustable drilling guide gauge 25 has been disengaged from the drilling guide ring 15 and the locking cylinder handle 10 and its attached locking cylinder 4 are now in the locked position inside the swivel guide platform 3 while the drilling guide 15 is now locked at its correct height and the surgical clamp apparatus is now fully set up to begin the bone drilling procedure for the osteotomy.

In FIGS. 11I-11J, implant drill hand piece attachment 17 with attached drill bit 18 and bushing 24 may be used to drill the desired bone preparation of the osteotomy through the drilling guide ring 15, at the pre-determined access angle, path or orientation and depth.

In FIG. 11K the completed osteotomy 41 can be seen from a top view perspective.

In FIG. 11L the pre-calibrated adjustable implant driver tool 19 with attached implant 23 (not shown) is inserted into the locked drill guide ring 15. The driver tool is utilized to drive (screw) the implant to the predetermined limiting drill depth set by the locked drill guide ring 15.

FIG. 11M shows a zoomed in top view perspective of the completed osteotomy 41 and implanted implant 23.

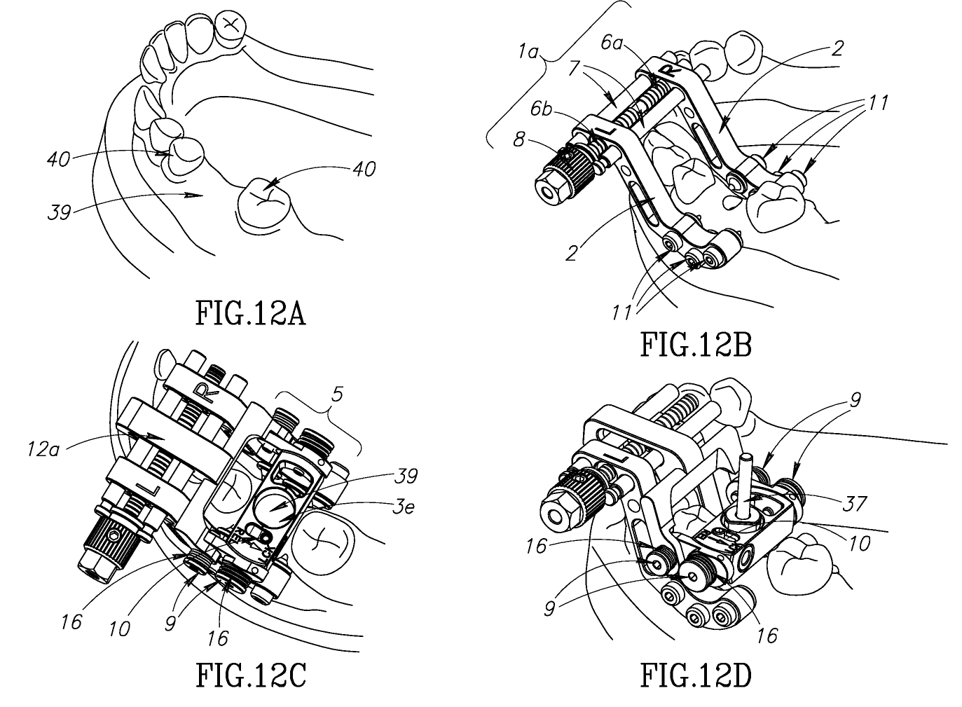

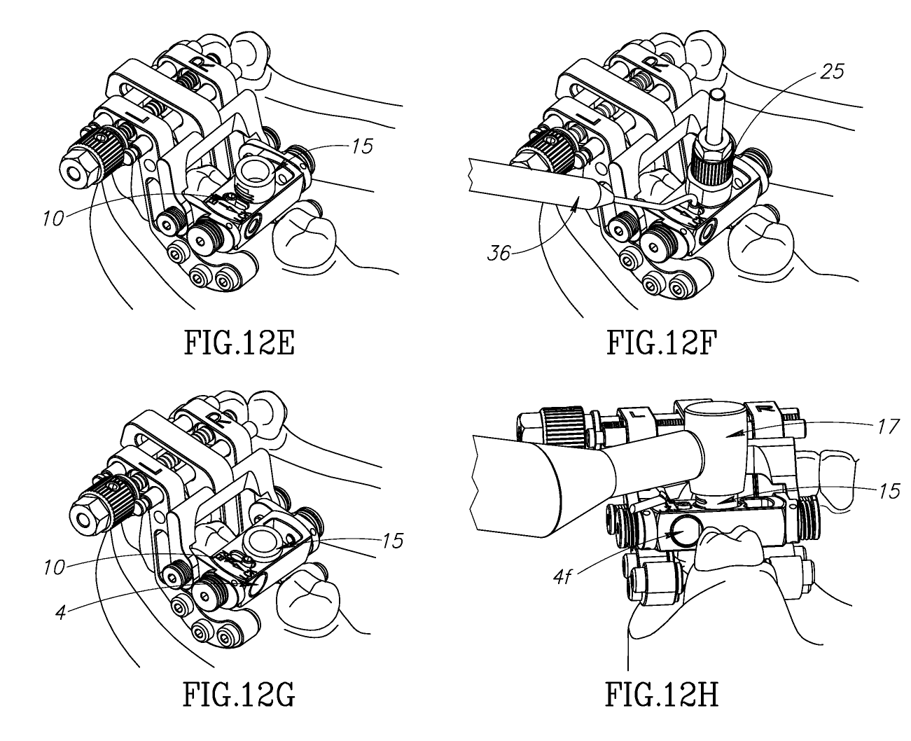

FIGS. 12A-12H are graphical illustrations of a setup for a delayed surgical implantation treatment using a surgical implant clamping apparatus, according to some embodiments of the present invention. As can be seen in FIGS. 12A-12B, after the surgical clamp outer frame 1a is placed and secured in position over the Target implant site 39. In FIG. 12B, the surgical clamp arms 2 are positioned by adjusting the Right section of Right/Left bolt 6a and the Left section of Right/Left bolt 6b, thereby fixing guide pins 7 in place, by tightening Right/Left bolt adjusting knob 8. This presses and self-adjusts the respective fixation swivel cleats 11 to the gums and underlying bony buccal and lingual plates of the jawbone. In FIG. 12C the inner frame guide assembly 5 is attached and secured to the surgical clamp outer frame 1a, and the center bore 3e of the swivel guide platform 3 is positioned over the target implant site 39 by adjusting the locking screws and springs 9 and 16 of the guide assembly articulating arms 13 to the guide assembly main frame 12, as well as sliding and positioning in a buccal lingual axis the guide assembly main frame 12, and optionally locking its position with the guide assembly main frame attachment screw 14.

In FIG. 12D the swivel guide platform orientation element 37 is inserted into the center bore 3e of the swivel guide platform 3 to set the orientation angle, tilt, and position of the swivel guide platform 3 for drilling. The respective guide assembly locking screws 9 with locking screw springs 16 are tightened, and locked in position to secure the swivel guide platform 3.

In FIG. 12E the drill guide ring 15 is inserted into the center bore 3e of the swivel guide platform 3 and then the pre-calibrated adjustable drilling guide gauge 25 is inserted into it, or alternatively the drill guide ring 15 is first coupled to the drilling guide gauge 25 and then the two connected components are together inserted into the center bore 3e of the swivel guide platform 3.

In FIG. 12F the already calibrated adjustable drilling guide gauge 25 (previously calibrated using the pre-calibrating device 30) may be inserted into the drill guide ring 15 or the two together as described above are inserted into the center bore 3e, and they are together pushed down till the pointed tip of the guide gauge inner shaft penetrates through the overlying gum tissue and rests on the crestal bone of the target bone site 39. Clamp apparatus double ended hand tool 36 or another tool may then be used to move locking cylinder handle 10 into lock position, thereby engaging guide ring locking cylinder 4, to create a depth limiter that sets the drill guide height.

In FIGS. 12G-12H, after gauge 25 is removed, implant drill hand piece attachment 17 with attached drill bit 18 and bushing 24 (not shown) may be used to drill the desired hole through drilling guide ring 15. The drilling and implant procedures may be continued from this point similarly to that as described above in relation to FIGS. 11J-11M, for both the immediate and delayed surgical procedures.

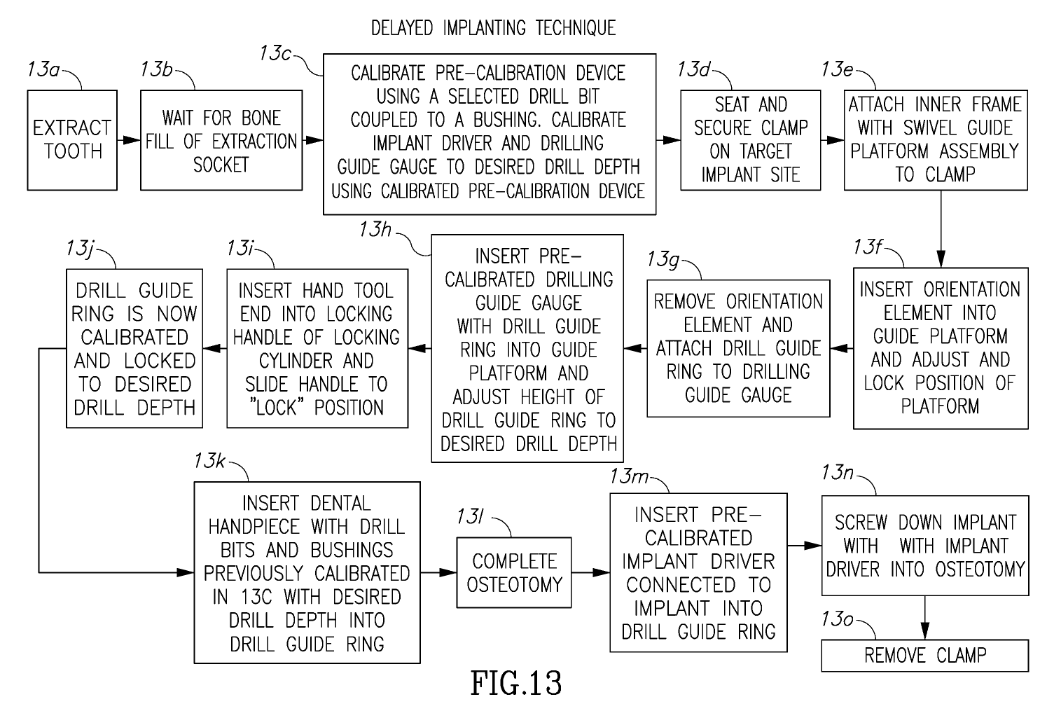

FIG. 13 is a flow chart that describes a series of operations or processes that may be implemented to prepare a jaw bone for delayed placement of a dental implant, according to some embodiments. As can be seen in FIG. 13, at step 13a, the tooth or teeth needing to be replaced by an implant is extracted. At step 13b, the bone is given time to fill the socket of the extracted tooth. At step 13c, prior to the implant preparation and installation procedure, the selected drill bit is used to calibrate the pre-calibration device, implant driver and drilling guide gauge may then be calibrated to a desired drill depth, with the now calibrated pre-calibration device. At step 13d, a surgical guide clamp outer frame is seated on the target site. At step 13e, the inner frame with swivel guide platform assembly may be attached to the clamp. At step 13f, the orientation element may be inserted into the guide platform and adjusted, and position of platform may be locked. At step 13g, the orientation element may be removed, and the drill guide ring attached to the drilling guide gauge. In 13h, the pre-calibrated drilling guide gauge with drill guide ring may be inserted into the guide platform, and the height of the drill guide ring may be adjusted to the desired drill depth. At step 13i, the hand tool end may be inserted into the locking handle of the locking cylinder, and the handle may be slid into “lock” position. At step 13j, the drill guide ring is now calibrated and locked to desired drill depth. At step 13k, the dental hand piece with drill bits and bushings previously used to calibrate the pre-calibration device may be inserted into the drill guide ring, to complete the Osteotomy at step 13L to the desired angle, direction of angle and drill depth. At step 13m, the pre-calibrated implant driver connected to the implant may be inserted into the drill guide ring. At step 13n, the implant may be screwed down with the implant driver, into the Osteotomy. At step 13o, the clamp may be removed. Further, other steps or series of steps may be used.

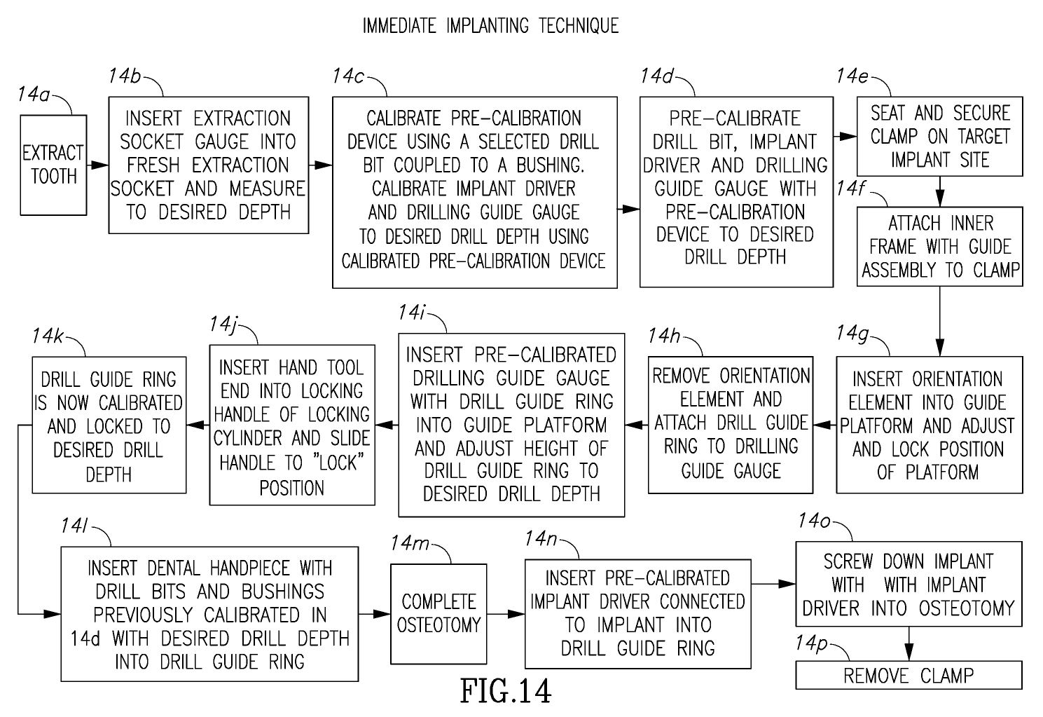

FIG. 14 is a flow chart that describes a series of operations or processes that may be implemented to prepare a jaw bone for immediate placement of a dental implant after extraction of a tooth, according to some embodiments. As can be seen in FIG. 14, at step 14a, the tooth or teeth needing to be replaced by an implant is extracted. At step 14b, the extraction socket gauge may be inserted into the fresh extraction socket and measured to desired depth. At step 14c, the extraction socket gauge may be removed from the extraction socket. At step 14d, the selected drill bit is inserted into the pre-calibration device in order to calibrate it and the implant driver and drilling guide gauge may now be inserted into the outer segment of the cutout of the upper element of the pre-calibration device and calibrated to a desired drill depth, with the pre-calibration device. At step 14e, a surgical guide clamp outer frame is seated and secured on the target site. At step 14f, the inner frame with swivel guide platform assembly may be attached to the clamp. At step 14g, the orientation element may be inserted into the guide platform and adjusted by inserting the drill bit (used to calibrate the pre-calibration device) through the bore of the orientation element and into the extraction socket so as to act as a guide along the bony walls of the socket, and position of platform may be locked. At step 14h, the orientation element and drill bit may be removed, and the drill guide ring attached to the drilling guide gauge. In 14i, the pre-calibrated drilling guide gauge with drill guide ring may be inserted into the guide platform, and the height of the drill guide ring may be adjusted to the desired drill depth. At step 14j, the hand tool end may be inserted into the locking handle of the locking cylinder, and the handle may be slid into “lock” position. At step 14k, the drilling guide gauge is removed from the drill guide ring and the drill guide ring is now calibrated and locked to desired drill depth. At step 14L, the dental hand piece with drill bits and bushings previously used to calibrate the pre-calibration device may be inserted into the drill guide ring, to complete the Osteotomy at step 14m to the desired angle, direction of angle and depth. At step 14n, the pre-calibrated implant driver connected to the implant may be inserted into the drill guide ring. At step 14o, the implant may be screwed down with the implant driver, into the Osteotomy. At step 14p, the clamp may be removed. Further, other steps or series of steps may be used.

According to some embodiments, a kit is provided that includes any combination of two or more of an implant driver tool, a drill guide gauge, an extraction socket gauge, an orientation element or a calibration device.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. An apparatus comprising:
i. an outer frame including two or more clamp arms for clamping to opposing sides of a bone;
ii. an inner frame separately attachable to the clamped outer frame to enable sequential attachment of the outer and inner frame with respect to the bone; and
iii. a platform suitable for being positioned over a bone and maintained in position for a procedure including preparing a bone for an implant and/or implanting an implant into a bone, the platform having threaded bores on side surfaces thereof that connect to the inner frame using locking screw elements, said platform having a guide bore therethrough.

2. The apparatus of claim 1 further comprising a plurality of individually engageable fixation cleats connectable to each arm, wherein at least one of the fixation cleats has a swivel tip suitable for self-aligning and penetrating into a bone and/or gum tissue on the opposing sides of the bone so that the outer frame is secured to the bone during the procedure.

3. The apparatus of claim 1, wherein the inner frame has at least two articulating arms being connectable to the platform.

4. The apparatus as claimed in claim 1, wherein the two or more clamp arms are connected by one or more guide pins and a right or left threaded bolt to enable the two clamp arms to be adjusted simultaneously.

5. The apparatus of claim 1, wherein the platform comprises a single platform connectable to the inner frame at opposing end walls of the platform, said opposing end walls of the platform being curved to allow swiveling of the platform within the inner frame thereby enabling changing of the direction of an angle of the platform relative to the bone, so that the apparatus can be used for preparing dental osteotomies having bores with different angles and different directions of the each said angles.

6. The apparatus of claim 1, wherein the guide bore is provided through a top surface of the platform and receives a guide member for receiving a surgical component, the position of the guide member within the guide bore of the platform being adjustable to change the effective height of the guide member relative to the bone.

7. The apparatus of claim 1, wherein the platform guide bore is adapted to receive an orientation member to aid in the orientation of the platform.

8. The apparatus of claim 6 wherein the platform further includes a locking mechanism for locking the guide member at a selected position relative to the platform.

9. The apparatus of claim 6, wherein the guide member is in the form of a hollow cylinder, the outer wall of the cylinder having a series of fixed projections or teeth for mating with a corresponding projection or tooth that is moveable into and out of the bore thereby enabling engagement with and disengagement from a projection or tooth of the guide member with respect to the platform.

10. The apparatus of claim 1, wherein the clamp arms of the outer frame have an upper region that extend above the crestal height and the occlusal plane of the teeth, wherein the upper region of the clamp arms have a plurality of bore holes and are connected by one or more clamp arm connection screws extending through a bore hole of each clamp arm and by one or more clamp arm guide pins extending through a bore hole of each arm, wherein the bore holes are aligned so that the clamp arms are maintained in a generally parallel relationship.

11. The apparatus of claims 1, wherein the each clamp arm of the outer frame has internally threaded bore holes for each of the cleats so that the each of the cleats can be screwed individually against the gum, and the clamp arm connection screw has a knob for screwing the arms together so that the cleats can evenly penetrate the gum tissue and/or the bone independent of the curvature of the gum tissue and/or bone.

12. The apparatus of any of claim 2, wherein one or more of the cleat tips is a self-adjusting rotatable tip with a separate self-adjusting limiting face.

13. The apparatus of claim 1, wherein the inner frame includes a guide assembly main frame attachment section inner surface for engaging over the guide pins and the right or left threaded bolt of the outer frame, and an element bore for insertion of a guide assembly attachment screw to secure the inner frame to the clamped outer frame.

14. The apparatus of claim 13 wherein the inner frame slideably engages the guide pins and the right or left threaded bolt of the outer frame.

15. The apparatus of claim 3, wherein each of the articulating arms has a curved inner surface for receiving the platform with a curved inner surface, thereby enabling the connected platform to swivel in all directions.

16. The apparatus according claim 1, wherein the apparatus includes one or more features for positioning the platform, swiveling the platform, changing a position of the platform, changing an angle component of the platform relative to the bone, locking the platform at a selected position relative to the support arms or any combination thereof, following the securement of the clamp arms of the outer frame to the bone and prior to the procedure.

17. The use of an apparatus as in claimed 1, for preparing a dental osteotomy and/or implanting a dental implant into a jaw bone.

18. A kit comprising any combination of a clamping apparatus as claimed in claim 1, and at least one of, an implant driver tool, a drill guide gauge, an extraction socket gauge, an orientation member or a calibration device.

19. A process comprising the steps of:
i. clamping a dental implantation apparatus to a jawbone, wherein the dental implantation apparatus includes an outer frame having two arms each having a lower portion that extends along opposing sides of a jawbone, and the apparatus includes a plurality of cleats protruding from each arm of the outer frame, and the step of clamping the apparatus includes inserting and engaging a plurality of the cleats into gum tissue and/or into the bone;
ii. after clamping, attaching to the outer frame an inner frame including vertical cross members with attachable articulating arms;
iii. attaching to the articulating arms of the inner frame a platform for the insertion of one or more tools for preparing an osteotomy and/or for implanting a dental implant into a jawbone;
iv. adjusting the position of the platform relative to the jawbone after the apparatus has been attached to the jawbone; and
v. maintaining the position of the platform while performing one or more steps of preparing an osteotomy and/or implanting a dental implant.

20. The process of claim 19, wherein the step of adjusting the platform includes a step of adjusting one or any combinations of the following:
i. adjusting the buccal to lingual position of the platform;
ii. adjusting the tilt angle of at least a portion of the platform relative to the vertical axis;
iii. adjusting the anterior to posterior position of the platform; and/or
iv. adjusting the direction of the projection of the tilt angle of the at least a portion of the platform onto the plane perpendicular to the vertical axis.
